(19) United States
(12) Patent Application Publication
(10) Pub. No.: US 2024/0187894 A1
(43) Pub. Date: Jun. 6, 2024

(54) ELECTRONIC DEVICE FOR TRANSMITTING MEASUREMENT REPORT AND OPERATING METHOD OF THE SAME

(71) Applicant: SAMSUNG ELECTRONICS CO., LTD., Suwon-si (KR)

(72) Inventors: Junsuk KIM, Suwon-si (KR); Minho YANG, Suwon-si (KR); Jinwoo KIM, Suwon-si (KR); Sungjin PARK, Suwon-si (KR); Junyoung WOO, Suwon-si (KR); Chaeman LIM, Suwon-si (KR); Euichang JUNG, Suwon-si (KR)

(21) Appl. No.: 18/463,760

(22) Filed: Sep. 8, 2023

Related U.S. Application Data
(63) Continuation of application No. PCT/KR2022/012278, filed on Aug. 18, 2023.

(30) Foreign Application Priority Data
Dec. 2, 2022 (KR) 10-2022-0166837
Dec. 21, 2022 (KR) 10-2022-0180107

(51) Int. Cl. H04W 24/08; H04W 24/10

(52) U.S. Cl. CPC H04W 24/08; H04W 24/10

(57) ABSTRACT

In an electronic device and/or an operating method of the electronic device, the electronic device may include first and second antenna modules, and a communication processor. The communication processor may be configured to receive, from a cellular network, a measurement configuration (e.g., measConfig) related to measurement of a quality of a signal having a first frequency band and measurement of a quality of a signal having a second frequency band, to measure the quality of the signal having the first frequency band by using the first antenna module and the second antenna module, to select one antenna module among the first antenna module and the second antenna module, based on the results of the measurement, to transmit, to the cellular network, a measurement report including the quality of the signal having the first frequency band, which has been measured by a selected antenna module, when the quality of the signal having the first frequency band, which has been measured by the selected antenna module, satisfies a condition included in the measurement configuration, and to transmit, to the cellular network, a measurement report including the quality of the signal having the second frequency band, which has been measured by an unselected antenna module, when the quality of the signal having the second frequency band, which has been measured by the unselected antenna module, satisfies the condition included in the measurement configuration. In addition, various other embodiments are possible.

### CROSS-REFERENCE TO RELATED APPLICATIONS

This application is continuation of International Application No. PCT/KR2023/012278 filed on Aug. 18, 2023, designating the United States, in the Korean Intellectual Property Receiving Office, and claiming priority to Korean Patent Application No. 10-2022-0166837 filed on Dec. 2, 2022, and to Korean Patent Application No. 10-2022-0180107 filed on Dec. 21, 2022, in the Korean Intellectual Property Office, the disclosures of all of which are hereby incorporated by reference herein in their entireties.

### BACKGROUND

### Field

Various example embodiments relate to an electronic device and/or an operating method of the electronic device, and/or relate to an electronic device for transmitting a measurement report.

### Background Art

In order to satisfy wireless data traffic demands that tend to increase after 4G communication system commercialization, efforts to develop an enhanced 5G communication system or a pre-5G communication system are being made. For this reason, the 5G communication system or the pre-5G communication system is called a beyond 4G network communication system or a post LTE system. In order to achieve a high data transfer rate, an implementation of the 5G communication system in a mmWave band (e.g., such as a 6 Giga (6 GHz) band or higher) is taken into consideration in addition to a band (such as a 6 Giga (6 GHz) band or less) that was used by LTE. Beamforming, massive MIMO, full dimensional MIMO (FD-MIMO), an array antenna, analog beamforming, and large scale antenna technologies are being discussed in the 5G communication system.

An electronic device that transmits and/or receives data through 5G cellular communication can support an inter-band carrier aggregation. The electronic device that supports the inter-band carrier aggregation may transmit and/or receive data to a cellular network through nodes that support different frequency bands.

### SUMMARY

An electronic device may measure the quality of a signal based on a measurement configuration that is received from a cellular network for the activation of a carrier aggregation. The electronic device that has measured the quality of the signal may transmit, to the cellular network, a measurement report including, the quality of the signal when the results of the measurement satisfy a report condition. However, the measurement report may include the quality of the signal, but may not include the ID of communication circuitry that has measured the quality of the signal. If the communication circuitry that has measured the quality of the signal does not support the simultaneous reception and/or transmission of signals having different frequency bands, the execution of the carrier aggregation may be impossible. Communication circuitry that does not support the simultaneous reception and/or transmission of signals having different frequency bands may sequentially perform the measurements of the qualities of signals having different frequency bands, but may have a difficulty to perform a carrier aggregation that requires the simultaneous reception and/or transmission of signals having different frequency bands.

Example non-limiting objects to be solved in this document are not limited to those herein, and other objects not described above may be evidently understood from the following description by a person having ordinary knowledge in the art to which the disclosure pertains.

An electronic device according to an example embodiment may include a first antenna module comprising at least one antenna. The electronic device may include a second antenna module comprising at least one antenna. The electronic device may include a communication processor comprising processing circuitry. The communication processor may receive, from a cellular network, a measurement configuration (measConfig) related to the measurement of the quality of a signal having a first frequency band and the measurement of the quality of a signal having a second frequency band. The communication processor may measure the quality of the signal having the first frequency band by using the first antenna module and the second antenna module. The communication processor may select one of antenna module among the first antenna module and the second antenna module, based on results of the measurement. The communication processor may transmit, to the cellular network, a measurement report including the quality of the signal having the first frequency band, which has been measured by a selected antenna module, when the quality of the signal having the first frequency band, which has been measured by the selected antenna module, satisfies a condition included in the measurement configuration. The communication processor may be configured to transmit, to the cellular network, a measurement report including the quality of the signal having the second frequency band, which has been measured by an unselected antenna module, when the quality of the signal having the second frequency band, which has been measured by the unselected antenna module, satisfies the condition included in the measurement configuration.

An operating method of an electronic device according to an example embodiment may include an operating of receiving, from a cellular network, a measurement configuration (e.g., measConfig) related to the measurement of a quality of a signal having a first frequency band and measurement of a quality of a signal having a second frequency band. The operating method of the electronic device may include an operation of measuring the quality of the signal having the first frequency band by using the first antenna module and the second antenna module. The operating method of the electronic device may include an operating of selecting one of antenna module among a first antenna module and a second antenna module, based on the results of the measurement. The operating method of the electronic device may include an operating of transmitting, to the cellular network, a measurement report including the quality of the signal having the first frequency band, which has been measured by a selected antenna module, when the quality of the signal having the first frequency band, which has been measured by the selected antenna module, satisfies a condition included in the measurement configuration. The operating method of the electronic device may include an operating of transmitting, to the cellular network, a measurement report including the quality of the signal having the second frequency band, which has been measured by an unselected antenna module, when the quality of the signal having the second frequency band, which has been measured by the unselected antenna module, satisfies the condition included in the measurement configuration.

In the electronic device and the operating method of the electronic device according to example embodiments, a measurement report including the quality of a signal having a first frequency band, which has been measured by a selected antenna module, and a measurement report including the quality of a signal having a second frequency band, which has been measured by an unselected antenna module, may be transmitted based on the results of the measurement of the quality of the signal. Accordingly, an example electronic device can match communication circuitry that has performed the measurement of the quality of a signal included in a measurement report that is transmitted to a cellular network with communication circuitry with which communication will be performed in an inter-band carrier aggregation. Accordingly, if the communication circuitry that has performed the measurement of the quality of the signal included in the measurement report that is transmitted to the cellular network with the communication circuitry with which communication will be performed in the inter-band carrier aggregation are not matched, the example electronic device can prevent or reduce chances of a situation in which an inter-band carrier aggregation is performed, and can prevent or reduce deterioration of communication performance.

Effects of the disclosure which may be obtained in the disclosure are not limited to the aforementioned effects, and other effects not described above may be evidently understood by a person having ordinary knowledge in the art to which the disclosure pertains from the following description.

### BRIEF DESCRIPTION OF DRAWINGS

In connection with the description of the drawings, the same or similar reference numerals may be used for the same or similar elements. Other aspects, features and advantages according to specific example embodiments will become more apparent from the accompanying drawings and corresponding descriptions in association.

FIG. 1 is a block diagram of an electronic device according to various example embodiments.

FIG. 2 is a block diagram of an electronic device for supporting legacy network communication and 5G network communication according to various example embodiments.

FIG. 3 is a diagram illustrating a protocol stack structure of a network 100 for legacy communication and/or 5G communication according to an example embodiment.

FIGS. 4A, 4B and 4C are diagrams illustrating wireless communication systems that provide networks for legacy communication and/or 5G communication according to various example embodiments.

FIG. 5A is a diagram illustrating an electronic device and a cellular network according to an example embodiment.

FIG. 5B is a diagram illustrating an electronic device and a cellular network according to an example embodiment.

FIG. 6 is a block diagram of an electronic device according to an example embodiment.

FIG. 7 is a diagram illustrating an example embodiment in which an electronic device according to an embodiment transmits a measurement report to a cellular network.

FIG. 8 is a diagram illustrating an example embodiment in which an electronic device according to an embodiment transmits a measurement report for an inter-band connection.

FIG. 9 is a diagram illustrating an example embodiment in which an electronic device according to an embodiment transmits a measurement report for an inter-band connection.

FIG. 10 is an operational flowchart illustrating an operating method of an electronic device according to an example embodiment.

FIG. 11 is an operational flowchart illustrating an operating method of an electronic device according to an example embodiment.

FIG. 12 is an operational flowchart illustrating an operating method of an electronic device according to an example embodiment.

### DETAILED DESCRIPTION

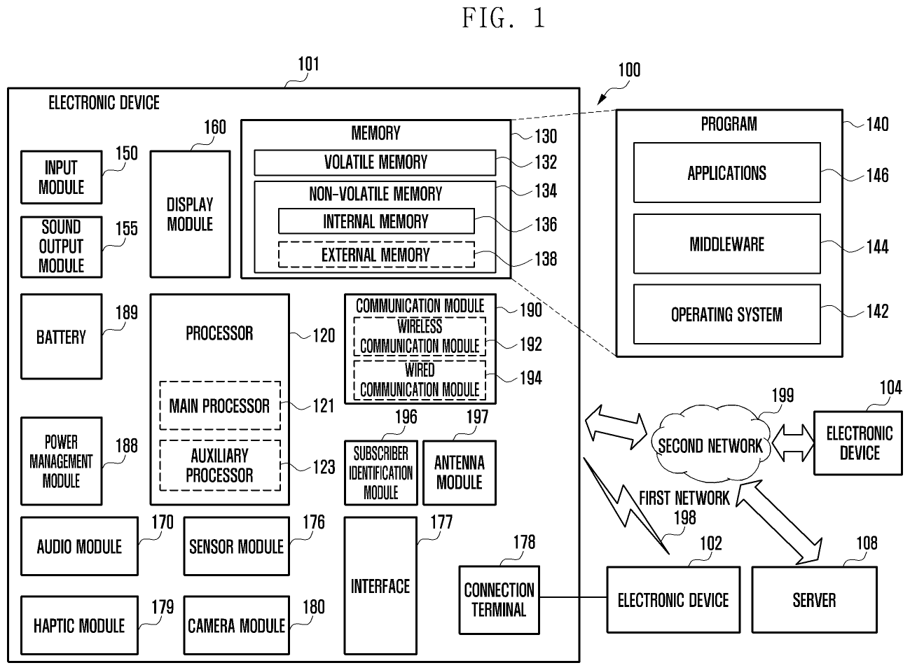

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

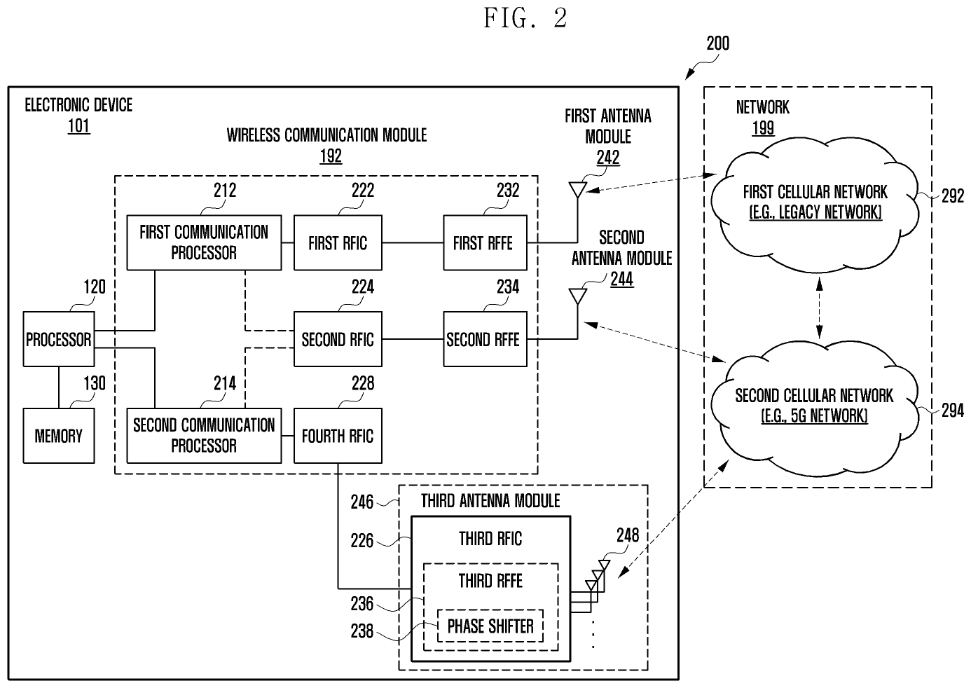

FIG. 2 is a block diagram 200 of an electronic device 101 for supporting legacy network communication and 5G network communication according to certain embodiments. Referring to FIG. 2, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include the processor 120 and the memory 130. The network 199 may include a first network 292 and a second network 294. According to another embodiment, the electronic device 101 may further include at least one component among the components illustrated in FIG. 1, and the network 199 may further include at least one other network. According to an embodiment, the first communication processor 212, the second communication processor 214, the first RFIC 222, the second RFIC 224, the fourth RFIC 228, the first RFFE 232, and the second RFFE 234 may be included as at least a part of the wireless communication module 192. According to another embodiment, the fourth RFIC 228 may be omitted or may be included as a part of the third RFIC 226.

The first communication processor 212 may establish a communication channel of a band to be used for wireless communication with the first network 292, and may support legacy network communication via the established communication channel. According to certain embodiments, the first network may be a legacy network including 2G, 3G, 4G, or long term evolution (LTE) network. The second communication processor 214 may establish a communication channel corresponding to a designated band (e.g., approximately 6 GHz to 60 GHz) among bands to be used for wireless communication with the second network 294, and may support 5G network communication via the established channel. According to certain embodiments, the second network 294 may be a 5G network defined in 3GPP. Additionally, according to an embodiment, the first communication processor 212 or the second communication processor 214 may establish a communication channel corresponding to another designated band (e.g., lower than 6 GHz) among bands to be used for wireless communication with the second network 294, and may support 5G network communication via the established channel. According to an embodiment, the first communication processor 212 and the second communication processor 214 may be implemented in a single chip or a single package. According to certain embodiments, the first communication processor 212 or the second communication processor 214 may be implemented in a single chip or a single package, together with the processor 120, the sub-processor 123, or the communication module 190.

In the case of transmission, the first RFIC 222 may convert a baseband signal generated by the first communication processor 212 into a radio frequency (RF) signal in a range of approximately 700 MHz to 3 GHz used for the first network 292 (e.g., a legacy network). In the case of reception, an RF signal is obtained from the first network 292 (e.g., a legacy network) via an antenna (e.g., the first antenna module 242), and may be preprocessed via an RFFE (e.g., the first RFFE 232). The first RFIC 222 may convert the preprocessed RF signal to a baseband signal so that the base band signal is processed by the first communication processor 212.

In the case of transmission, the second RFIC 224 may convert a baseband signal generated by the first communication processor 212 or the second communication processor 214 into an RF signal (hereinafter, a 5G Sub6 RF signal) of a Sub6 band (e.g., lower than 6 GHz) used for the second network 294 (e.g., 5G network). In the case of reception, a 5G Sub6 RF signal is obtained from the second network 294 (e.g., a 5G network) via an antenna (e.g., the second antenna module 244), and may preprocessed by an RFFE (e.g., the second RFFE 234). The second RFIC 224 may convert the preprocessed 5G Sub6 RF signal into a baseband signal so that the baseband signal is processed by a corresponding communication processor from among the first communication processor 212 or the second communication processor 214.

The third RFIC 226 may convert a baseband signal generated by the second communication processor 214 into an RF signal (hereinafter, a 5G Above6 RF signal) of a 5G Above6 band (e.g., approximately 6 GHz to 60 GHz) to be used for the second network 294 (e.g., 5G network). In the case of reception, a 5G Above6 RF signal is obtained from the second network 294 (e.g., a 5G network) via an antenna (e.g., the antenna 248), and may be preprocessed by the third RFFE 236. The third RFIC 226 may convert the preprocessed 5G Above6 RF signal to a baseband signal so that the base band signal is processed by the second communication processor 214. According to an embodiment, the third RFFE 236 may be implemented as a part of the third RFIC 226.

According to an embodiment, the electronic device 101 may include the fourth RFIC 228, separately from or as a part of the third RFIC 226. In this instance, the fourth RFIC 228 may convert a baseband signal generated by the second communication processor 214 into an RF signal (hereinafter, an IF signal) in an intermediate frequency band (e.g., approximately 9 GHz to 11 GHz), and may transfer the IF signal to the third RFIC 226. The third RFIC 226 may convert the IF signal to a 5G Above6 RF signal. In the case of reception, a 5G Above6 RF signal is received from the second network 294 (e.g., a 5G network) via an antenna (e.g., the antenna 248), and may be converted into an IF signal by the third RFFE 226. The fourth RFIC 228 may convert the IF signal to a baseband signal so that the base band signal is processed by the second communication processor 214.

According to an embodiment, the first RFIC 222 and the second RFIC 224 may be implemented as a single chip or at least a part of the single package. According to an embodiment, the first RFFE 232 and the second RFFE 234 may be implemented as a single chip or at least a part of the single package. According to an embodiment, at least one antenna module of the first antenna module 242 or the second antenna module 244 may be omitted, or may be combined with another antenna module so as to process RF signals in a plurality of bands.

According to an embodiment, the third RFIC 226 and the antenna 248 may be disposed in the same substrate, and may form the third antenna module 246. For example, the wireless communication module 192 or the processor 120 may be disposed in a first substrate (e.g., main PCB). In this instance, the third RFIC 226 is disposed in a part (e.g., a lower part) of the second substrate (e.g., a sub PCB) separate from the first substrate and the antenna 248 is disposed on another part (e.g., an upper part), so that the third antenna module 246 is formed. By disposing the third RFIC 226 and the antenna 248 in the same substrate, the length of a transmission line therebetween may be reduced. For example, this may reduce a loss (e.g., attenuation) of a signal in a high-frequency band (e.g., approximate 6 GHz to 60 GHz) used for 5G network communication, the loss being caused by a transmission line. Accordingly, the electronic device 101 may improve the quality or speed of communication with the second network 294 (e.g., 5G network).

According to an embodiment, the antenna 248 may be implemented as an antenna array including a plurality of antenna elements which may be used for beamforming. In this instance, the third RFIC 226 may be, for example, a part of the third RFFE 236, and may include a plurality of phase shifters 238 corresponding to a plurality of antenna elements. In the case of transmission, each of the plurality of phase shifters 238 may shift the phase of a 5G Above6RF signal to be transmitted to the outside of the electronic device 101 (e.g., a base station of a 5G network) via a corresponding antenna element. In the case of reception, each of the plurality of phase shifters 238 may shift the phase of the 5G Above6 RF signal received from the outside via a corresponding antenna element into the same or substantially the same phase. This may enable transmission or reception via beamforming between the electronic device 101 and the outside.

The second network 294 (e.g., 5G network) may operate independently (e.g., Stand-Along (SA)) from the first network 292 (e.g., a legacy network), or may operate by being connected thereto (e.g., Non-Stand Alone (NSA)). For example, in the 5G network, only an access network (e.g., 5G radio access network (RAN) or next generation RAN (NG RAN)) may exist, and a core network (e.g., next generation core (NGC)) may not exist. In this instance, the electronic device 101 may access an access network of the 5G network, and may access an external network (e.g., the Internet) under the control of the core network (e.g., an evolved packed core (EPC)) of the legacy network. Protocol information (e.g., LTE protocol information) for communication with the legacy network or protocol information (e.g., New Radio (NR) protocol information) for communication with the 5G network may be stored in the memory 230, and may be accessed by another component (e.g., the processor 120, the first communication processor 212, or the second communication processor 214).

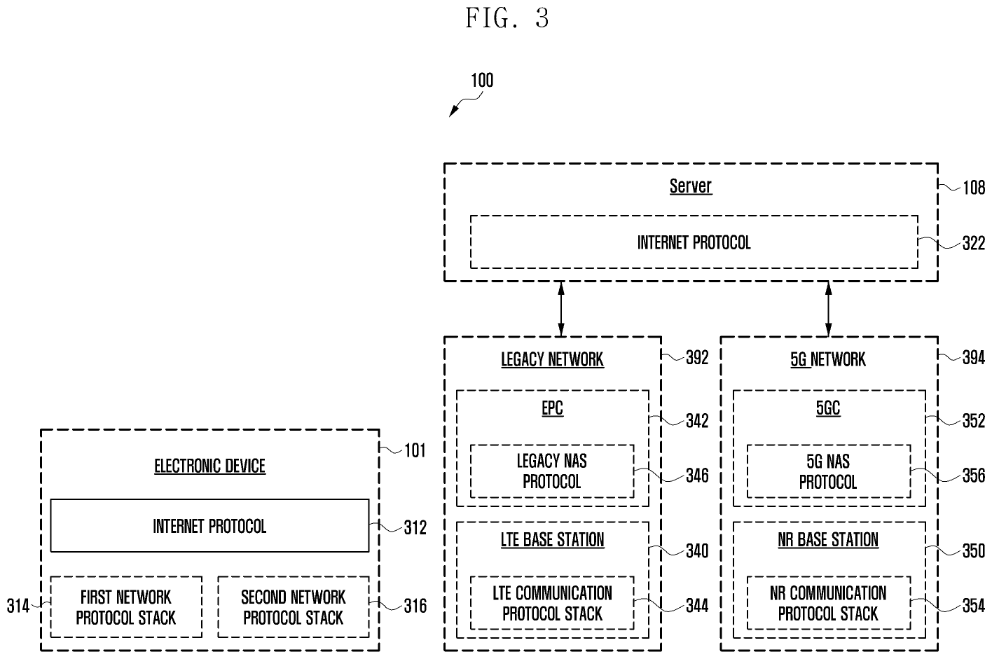

FIG. 3 illustrates a protocol stack structure of the network 100 of legacy communication and/or 5G communication according to an embodiment.

Referring to FIG. 3, the network 100 according to an illustrated embodiment may include the electronic device 101, a legacy network 392, a 5G network 394, and the server 108.

The electronic device 101 may include an Internet protocol 312, a first communication/network protocol stack 314, and a second communication/network protocol stack 316. The electronic device 101 may communicate with the server 108 through the legacy network 392 and/or the 5G network 394.

According to an embodiment, the electronic device 101 may perform Internet communication associated with the server 108 through the Internet protocol 312 (for example, a TCP, a UDP, or an IP). The Internet protocol 312 may be executed by, for example, a main processor (for example, the main processor 121 of FIG. 1) included in the electronic device 101.

According to another embodiment, the electronic device 101 may perform wireless communication with the legacy network 392 through the first communication protocol stack 314. According to another embodiment, the electronic device 101 may perform wireless communication with the 5G network 394 through the second communication protocol stack 316. The first communication protocol stack 314 and the second communication protocol stack 316 may be executed by, for example, one or more communication processors (for example, the wireless communication module 192 of FIG. 1) included in the electronic device 101.

The server 108 may include an Internet protocol 322. The server 108 may transmit and receive data related to the Internet protocol 322 to and from the electronic device 101 through the legacy network 392 and/or the 5G network 394. According to an embodiment, the server 108 may include a cloud computing server existing outside the legacy network 392 or the 5G network 394. According to another embodiment, the server 108 may include an edge computing server (or a mobile edge computing (MEC) server) located inside at least one of the legacy network 392 or the 5G network 394.

The legacy network 392 may include an LTE eNode B (eNB) 340 and an EPC 342. The LTE eNB 340 may include an LTE communication protocol stack 344. The EPC 342 may include a legacy NAS protocol 346. The legacy network 392 may perform LTE wireless communication with the electronic device 101 through the LTE communication protocol stack 344 and the legacy NAS protocol 346.

The 5G network 394 may include an NR gNB 350 and a 5GC 352. The NR gNB 350 may include an NR communication protocol stack 354. The 5GC 352 may include a 5G NAS protocol 356. The 5G network 394 may perform NR wireless communication with the electronic device 101 through the NR communication protocol stack 354 and the 5G NAS protocol 356.

According to an embodiment, the first communication protocol stack 314, the second communication protocol stack 316, the LTE communication protocol stack 344, and the NR communication protocol stack 354 may include a control plane protocol for transmitting and receiving a control message and a user plane protocol for transmitting and receiving user data. The control message may include a message related to at least one of, for example, security control, bearer setup, authentication, registration, or mobility management. The user data may include, for example, the remaining data other than the control message.

According to an embodiment, the control plane protocol and the user plane protocol may include a physical (PHY) layer, a medium access control (MAC) layer, a radio link control (RLC) layer, or a packet data convergence protocol (PDCP) layer. The PHY layer may channel-code and modulate data received from, for example, a higher layer (for example, the MAC layer), transmit the data through a radio channel, demodulate and decode the data received through the radio channel, and transmit the data to the higher layer. The PHY layer included in the second communication protocol stack 316 and the NR communication protocol stack 354 may further perform an operation related to beamforming. The MAC layer may logically/physically map, for example, data to a radio channel for transmitting and receiving the data and perform a hybrid automatic repeat request (HARQ) for error correction. The RLC layer may perform, for example, data concatenation, segmentation, or reassembly, and data sequence identification, reordering, or duplication detection. The PDCP layer may perform an operation related to, for example, ciphering of a control message and user data and data integrity. The second communication protocol stack 316 and the NR communication protocol stack 354 may further include a service data adaptation protocol (SDAP). The SDAP may manage allocation of radio bearers on the basis of quality of service (QoS) of user data.

According to certain embodiments, the control plane protocol may include a radio resource control (RRC) layer and a non-access stratum (NAS) layer. The RRC layer may process control, for example, data related to radio bearer setup, paging, or mobility management. The NAS may process, for example, a control message related to authentication, registration, or mobility management.

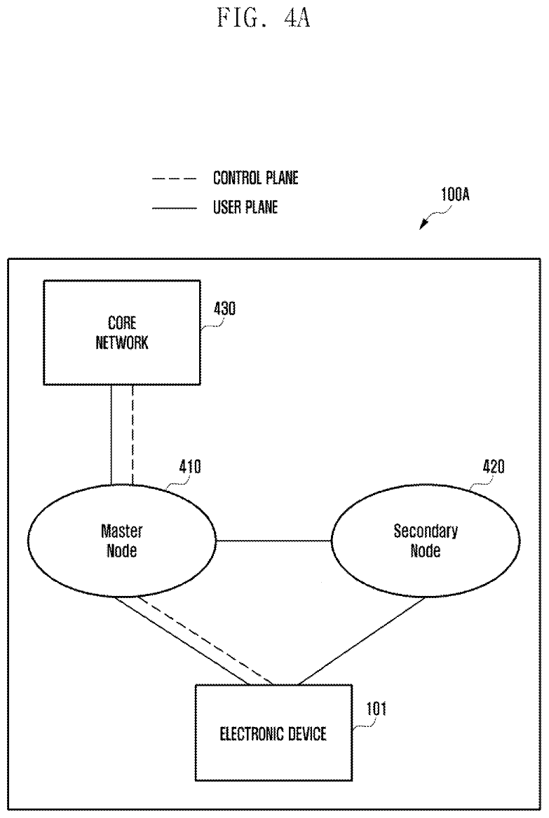

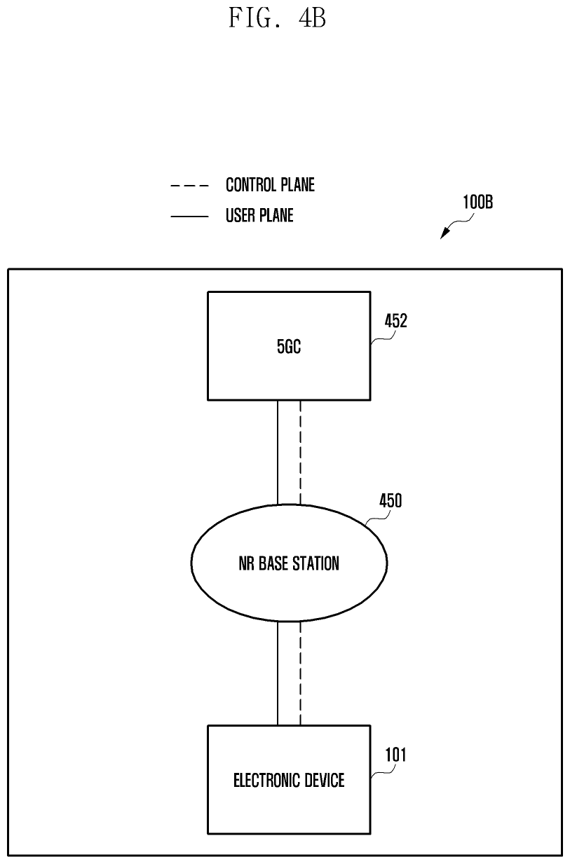

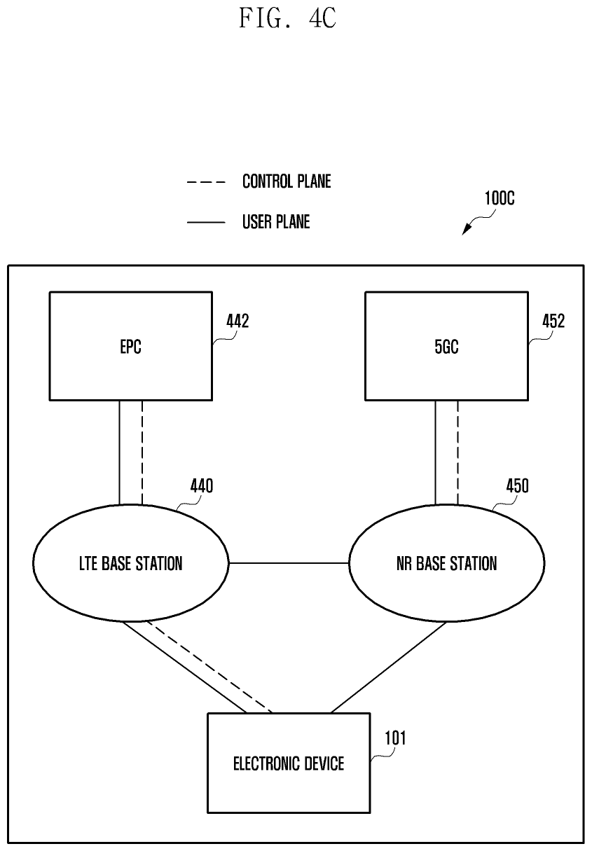

FIG. 4A illustrates a wireless communication system providing a network of legacy communication and/or 5G communication according to certain embodiments, FIG. 4B illustrates a wireless communication system providing a network of legacy communication and/or 5G communication according to certain embodiments, and FIG. 4C illustrates a wireless communication system providing a network of legacy communication and/or 5G communication according to certain embodiments. Referring to FIGS. 4A to 4C, network environments 100A to 100C may include at least one of a legacy network and a 5G network. The legacy network may include, for example, a 4G or LTE eNB 440 (for example, an eNodeB (eNB)) of the 3GPP standard supporting radio access with the electronic device 101 and an evolved packet core (EPC) 442 for managing 4G communication. The 5G network may include, for example, a new radio (NR) gNB 450 (for example, a gNodeB (gNB)) supporting radio access with the electronic device 101 and a 5th generation core (5GC) 452 for managing 5G communication of the electronic device 101.

According to certain embodiments, the electronic device 101 may transmit and receive a control message and user data through legacy communication and/or 5G communication. The control message may include, for example, a control message related to at least one of security control of the electronic device 101, bearer setup, authentication, registration, or mobility management. The user data may be, for example, user data other than a control message transmitted and received between the electronic device 101 and a core network 430 (for example, the EPC 442).

Referring to FIG. 4A, the electronic device 101 according to an embodiment may transmit and receive at least one of a control message or user data to and from at least some of the 5G network (for example, the NR gNB 450 and the 5GC 452) using at least some of the legacy network (for example, the LTE eNB 440 and the EPC 442).

According to certain embodiments, the network environment 100A may include a network environment for providing wireless communication dual connectivity (multi-radio access technology (RAT) dual connectivity (MR-DC)) to the LTE eNB 440 and the NR gNB 450 and transmitting and receiving a control message to and from the electronic device 101 through one core network 430 of the EPC 442 or the 5GC 452.

According to certain embodiments, one of the MR-DC environment, the LTE eNB 440 or the NR gNB 450 may operate as a master node (MN) 410, and the other may operate as a secondary node (SN) 420. The MN 410 may be connected to the core network 430 and transmit and receive a control message. The MN 410 and the SN 420 may be connected to each other through a network interface and transmit and receive a message related to radio resource (for example, communication channel) management.

According to certain embodiments, the MN 410 may include the LTE eNB 440, the SN 420 may include the NR gNB 450, and the core network 430 may include the EPC 442. For example, a control message may be transmitted and received through the LTE eNB 440 and the EPC 442, and user data may be transmitted and received through the LTE eNB 450 and the NR gNB 450.

Referring to FIG. 4B, according to certain embodiments, the 5G network may independently transmit and receive a control message and user data to and from the electronic device 101.

Referring to FIG. 4C, the legacy network and the 5G network according to certain embodiments may independently provide data transmission and reception. For example, the electronic device 101 and the EPC 442 may transmit and receive a control message and user data through the LTE eNB 440. According to another embodiment, the electronic device 101 and the 5GC 452 may transmit and receive a control message and user data through the NR gNB 450.

According to certain embodiments, the electronic device 101 may be registered in at least one of the EPC 442 or the 5GC 452 and transmit and receive a control message.

According to certain embodiments, the EPC 442 or the 5GC 452 may interwork and manage communication of the electronic device 101. For example, movement information of the electronic device 101 may be transmitted and received through an interface between the EPC 442 and the 5GC 452.

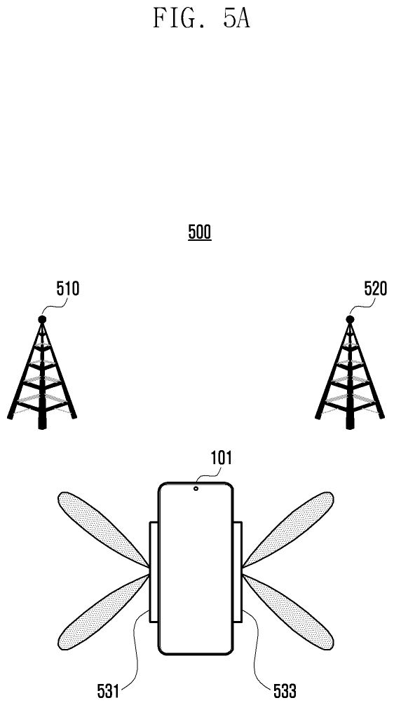

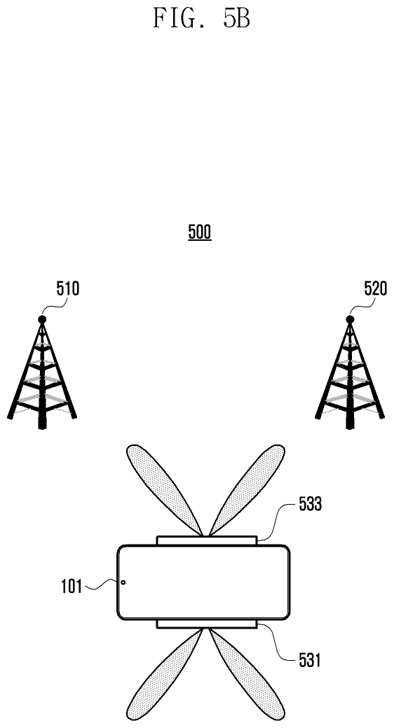

FIG. 5A is a diagram illustrating an electronic device and a cellular network according to an embodiment.

A cellular network 500 may include a first node 510 (e.g., the NR base station 450 in FIG. 4) and a second node 520 (e.g., the NR base station 450 in FIG. 4).

The first node 510 may be a base station supporting first cellular communication. The first cellular communication is any one communication method, among various cellular communication methods which may be supported by an electronic device (e.g., the electronic device 101 in FIG. 1), and may indicate a communication method over the second cellular network 294 in FIG. 2, for example. For example, the first cellular communication may be a communication method using a 5G mobile communication method (e.g., new radio (NR)). The electronic device 101 may be connected, directly or indirectly, to the first node 510, and may transmit or receive data.

The first node 510 may transmit or receive a signal having a first frequency band which is supported by the first cellular communication. When the electronic device 101 is connected to the cellular network 500 through the first node 510, the electronic device 101 may perform data communication by using the signal having the first frequency band supported by the first node 510.

The second node 520 may be a base station supporting the first cellular communication. The second node 520 may transmit or receive a signal having a second frequency band which is supported by the first cellular communication. When the electronic device 101 is connected to the cellular network 500 through the second node 520, the electronic device 101 may perform data communication by using the signal having the second frequency band supported by the second node 520.

The electronic device 101 may support an inter-band carrier aggregation. When the electronic device 101 supports an inter-band carrier aggregation, the electronic device 101 may be connected, directly or indirectly, to the first node 510 that supports the first frequency band and the second node 520 that supports the second frequency band, and may transmit and/or receive data through the first frequency band and the second frequency band.

In order to perform an inter-band carrier aggregation, the electronic device 101 may receive a measurement configuration for the measurement of the quality of a signal from the cellular network 500. The electronic device 101 may identify the measurement configuration included in an RRC reconfiguration message that is transmitted by the cellular network 500.

The measurement configuration may include a frequency band on which measurement will be performed by the electronic device 101, a measurement object including information on a synchronization signal block (SSB) on which measurement will be performed, a report configuration including a condition for reporting the quality of a signal measured by the electronic device 101 based on the measurement object and/or a measurement ID including the ID of the measurement object and measurement results of the quality of the signal.

According to an embodiment, the measurement object may include a first measurement object related to the measurement of the quality of the signal having the first frequency band and a second measurement object related to the measurement of the quality of the signal having the second frequency band.

According to an embodiment, when being connected to the first node 510 through the first frequency band, the electronic device 101 may receive an RRC reconfiguration message that is transmitted through the first node 510. The electronic device 101 may measure the quality of a signal having the first frequency band based on a first measurement object included in a measurement configuration that is included in the RRC reconfiguration message. The electronic device 101 may measure the quality of a signal having the second frequency band based on a second measurement object included in the measurement configuration that is included in the RRC reconfiguration message. When being connected, directly or indirectly, to the master node 410 in FIG. 4A, the electronic device 101 may receive an RRC reconfiguration message that is transmitted through a third node (e.g., master node 410). The electronic device 101 may measure the quality of the signal having the first frequency band based on a first measurement object included in a measurement configuration that is included in the RRC reconfiguration message. The electronic device 101 may measure quality of the signal having the second frequency band based on a second measurement object included in the measurement configuration that is included in the RRC reconfiguration message.

According to an embodiment, the electronic device 101 may include a plurality of antenna modules (e.g., a first antenna module 531 and a second antenna module 533). The electronic device 101 may measure the qualities of signals that are received through the first frequency band and/or the second frequency band by using the plurality of antenna modules, respectively.

According to an embodiment, the electronic device 101 may measure the quality of a signal having the first frequency band, which is received by the first antenna module 531, and may measure the quality of a signal having the first frequency band, which is received by the second antenna module 533. The electronic device 101 may identify whether a higher quality, among the two qualities, satisfies a report condition. When the higher quality satisfies the report condition, the electronic device 101 may transmit, to the cellular network 500, a measurement report including the higher quality. With reference to FIG. 5A, the quality of the signal having the first frequency band, which has been measured by the first antenna module 531 that is relatively closer to the first node 510 that outputs the signal having the first frequency band, may be higher than the quality of the signal having the first frequency band, which has been measured by the second antenna module 533. The quality of the signal having the first frequency band included in the measurement report may be a quality that is measured by the first antenna module 531.

According to an embodiment, the electronic device 101 may measure the quality of the signal having the second frequency band, which is received by the first antenna module 531, and may measure the quality of the signal having the second frequency band, which is received by the second antenna module 533. The electronic device 101 may identify whether a higher quality, among the two qualities, satisfies a report condition. When the higher quality satisfies the report condition, the electronic device 101 may transmit, to the cellular network 500, a measurement report including the higher quality. With reference to FIG. 5A, the quality of the signal having the second frequency band, which has been measured by the second antenna module 533 that is relatively closer to the second node 520 that outputs the signal having the second frequency band, may be higher than the quality of the signal having the second frequency band, which has been measured by the first antenna module 531. The quality of the signal having the second frequency band included in the measurement report may be a quality that is measured by the second antenna module 533.

When the quality of the signal having the first frequency band satisfies the report condition included in the measurement configuration, the electronic device 101 may transmit, to the cellular network 500, a measurement report including the quality of the signal having the first frequency band. The measurement report including the quality of the signal having the first frequency band may include the quality of the signal measured by the first antenna module 531. Furthermore, based on the quality of the signal having the second frequency band satisfying the report condition included in the measurement configuration, the electronic device 101 may transmit, to the cellular network 500, a measurement report including the quality of the signal having the second frequency band. The measurement report including the quality of the signal having the second frequency band may include the quality of the signal measured by the second antenna module 533.

The cellular network 500 may receive, from the electronic device 101, the measurement report including the quality of the signal having the first frequency band and/or the measurement report including the quality of the signal having the second frequency band. The electronic device 101 may perform a series of procedures for performing an inter-band carrier aggregation. The cellular network 500 may transmit, to the electronic device 101, the first node 510 and/or the second node 520, a signal to instruct that the electronic device 101 be connected to the first node 510 and/or the second node 520. The electronic device 101 may receive a signal to instruct that the electronic device 101 be connected to the first node 510 and/or the second node 520, and may perform a series of procedures of the electronic device 101 being connected to the first node 510 and/or the second node 520.

FIG. 5B is a diagram illustrating an electronic device and a cellular network according to an embodiment.

With reference to FIG. 5B, the quality of a signal that is measured by the first antenna module 531 and/or the second antenna module 533 may be changed as the direction of the electronic device 101 is changed.

According to an embodiment, the electronic device 101 may measure the quality of a signal having the first frequency band, which is received by the first antenna module 531, and may measure the quality of the signal having the first frequency band, which is received by the second antenna module 533. The electronic device 101 may identify whether a higher quality, among the two qualities, satisfies a report condition. When the higher quality satisfies the report condition, the electronic device 101 may transmit to the cellular network 500, a measurement report including the higher quality. With reference to FIG. 5B, the quality of the signal having the first frequency band, which has been measured by the first antenna module 531 that is relatively closer to the first node 510 that outputs the signal having the first frequency band may be higher than the quality of the signal having the first frequency band, which has been measured by the second antenna module 533.

According to an embodiment, the electronic device 101 may measure the quality of the signal having the second frequency band, which is received by the first antenna module 531, and may measure the quality of the signal having the second frequency band, which is received by the second antenna module 533. The electronic device 101 may identify whether a higher quality, among the two qualities, satisfies a report condition. When the higher quality satisfies the report condition, the electronic device 101 may transmit to the cellular network 500, a measurement report including the higher quality. With reference to FIG. 5B, the quality of the signal having the second frequency band, which has been measured by the first antenna module 531 that is relatively closer to the second node 520 that outputs the signal having the second frequency band may be higher than the quality of the signal having the second frequency band, which has been measured by the second antenna module 533.

When the quality of the signal having the first frequency band satisfies a report condition included in the measurement configuration, the electronic device 101 may transmit to the cellular network 500, a measurement report including the quality of the signal having the first frequency band. The measurement report including the quality of the signal having the first frequency band may include the quality of the signal measured by first antenna module 531. Furthermore, based on the quality of the signal having the second frequency band satisfying the report condition included in the measurement configuration, the electronic device 101 may transmit to the cellular network 500, a measurement report including the quality of the signal having the second frequency band. The measurement report including the quality of the signal having the second frequency band may include the quality of the signal measured by first antenna module 531.

The cellular network 500 may receive, from the electronic device 101, the measurement report including the quality of the signal having the first frequency band and/or the measurement report including the quality of the signal having the second frequency band. The electronic device 101 may perform a series of procedures for performing an inter-band carrier aggregation. The cellular network 500 may transmit to the electronic device 101, the first node 510 and/or the second node 520, a signal to instruct that the electronic device 101 be connected to the first node 510 and/or the second node 520. The electronic device 101 may receive the signal to instruct that the electronic device 101 be connected to the first node 510 and/or the second node 520, and may perform a series of procedures of the electronic device 101 being connected to the first node 510 and/or the second node 520.

However, if the first antenna module 531 does not support the simultaneous reception and/or transmission of signals having the first frequency band and/or the second frequency band, the electronic device 101 may have a difficulty in performing an inter-band carrier aggregation. According to an embodiment, if the first antenna module 531 does not support the simultaneous reception and/or transmission of signals having the first frequency band and/or the second frequency band, the electronic device 101 may perform the transmission and/or reception of a signal having the first frequency band by using the first antenna module 531, and may perform the transmission and/or reception of a signal having the second frequency band by using the second antenna module 533.

According to an embodiment, if the quality of the signal having the second frequency band, which has been measured by the second antenna module 533, is lower, the electronic device 101 may be in a situation in which the electronic device 101 cannot perform the inter-band carrier aggregation. The measurement report transmitted by the electronic device 101 may include the quality of the signal having the second frequency band, which has been measured by the first antenna module 531 not the second antenna module 533. Accordingly, the cellular network 500 that has received the measurement report may transmit, to the electronic device 101, a signal to instruct that the electronic device 101 be connected to the second node 520 for the inter-band carrier aggregation although the electronic device 101 is in the situation in which the electronic device 101 cannot perform the inter-band carrier aggregation. When receiving the signal to instruct the connection with the second node 520 for the carrier aggregation, the electronic device 101 may be connected, directly or indirectly, to the second node 520 through the second frequency band. The electronic device 101 may control the first antenna module 531 to transmit the signal having the first frequency band to the first node 510, and may control the second antenna module 533 to transmit the signal having the second frequency band to the second node 520. The second antenna module 533 may not receive the signal having the second frequency band, and performance of cellular communication that is performed by the electronic device 101 may be degraded.

The phenomenon may occur because communication circuitry that has performed the measurement of the quality of a signal included in a measurement report that is transmitted to the cellular network 500 and communication circuitry with which communication will be performed in an inter-band carrier aggregation are different from each other. According to an embodiment, the measurement of the quality of a signal having the second frequency band is performed by the first antenna module 531, but the transmission and/or reception of a signal having the second frequency band may be performed by the second antenna module 533.

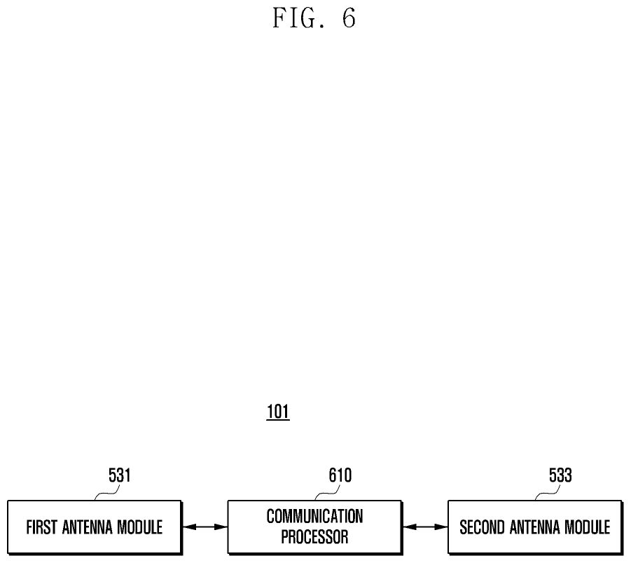

FIG. 6 is a block diagram of an electronic device according to an embodiment.

With reference to FIG. 6, an electronic device (e.g., the electronic device 101 in FIG. 1) according to various example embodiments may include a first antenna module 531 (e.g., the third antenna module 246 in FIG. 2), a second antenna module 533 (e.g., the third antenna module 246 in FIG. 2) and/or a communication processor 610 (e.g., the processor 120 in FIG. 1, the first communication processor 212 and/or the second communication processor 214 in FIG. 2). Each processor herein comprises processing circuitry.

The first antenna module 531 is communication circuitry which supports first cellular communication, and may provide the electronic device 101 with communication with an external electronic device (e.g., the electronic device 104 in FIG. 1) through the first cellular communication. The first antenna module 531 may also be denoted as first communication circuitry.

The second antenna module 533 is communication circuitry which supports the first cellular communication, and may provide the electronic device 101 with communication with an external electronic device (e.g., the electronic device 104 in FIG. 1) through the first cellular communication. The second antenna module 533 may also be denoted as second communication circuitry.

The electronic device 101 may further include communication circuitry (e.g., the wireless communication module 192 in FIG. 1) which supports the first cellular communication and second cellular communication.

Locations of the electronic device 101 at which the first antenna module 531 and the second antenna module 533 are disposed are not limited, but locations at which the first antenna module 531 and the second antenna module 533 are disposed for the transmission/reception of signals in various directions may be different. According to an embodiment, the first antenna module 531 may be disposed to radiate a signal on one side of the electronic device 101, and the second antenna module 533 may be disposed to radiate a signal on the other side of the electronic device 101.

The communication processor 610 may be operatively connected, directly or indirectly, to the first antenna module 531 and/or the second antenna module 533.

The communication processor 610 may perform the transmission and/or reception of data through the first cellular communication and/or the second cellular communication. The communication processor 610 may be connected, directly or indirectly, to a first node (e.g., the first node 510 in FIG. 5A) through the first cellular communication, and may be connected, directly or indirectly, to a second node (e.g., the second node 520 in FIG. 5A) through the first cellular communication. The communication processor 610 may be connected, directly or indirectly, to a third node (e.g., the master node 410 in FIG. 4A) through the second cellular communication.

The communication processor 610 may transmit user data received from an application processor (e.g., the processor 120 in FIG. 1) through the first cellular communication and/or the second cellular communication, and may transmit, to the application processor 120, user data received through the first cellular communication and/or the second cellular communication.

The first cellular communication is any one communication method, among various cellular communication methods supportable by the electronic device 101, and may indicate a communication method over the second cellular network 294 in FIG. 2, for example. For example, the first cellular communication may be a communication method using a 5G mobile communication method (e.g., new radio).

The second cellular communication is any one communication method, among various cellular communication methods supportable by an electronic device (e.g., the electronic device 101 in FIG. 1), and may indicate a communication method over the first cellular network 292 in FIG. 2, for example. For example, the second cellular communication may be a communication method using a 4G mobile communication method (e.g., long term evolution).

The communication processor 610 may receive an RRC reconfiguration message from the cellular network 500 based on a cellular network (e.g., the cellular network 500 in FIG. 5A) being connected thereto. According to an embodiment, in a non-standalone mode of the first cellular communication, the communication processor 610 may receive an RRC reconfiguration message that is transmitted by the cellular network 500 through the third node 410. According to an embodiment, in a standalone mode (SA) of the first cellular communication, the communication processor 610 may receive an RRC reconfiguration message that is transmitted by the cellular network 500 through the first node 510 or the second node 520.

The RRC reconfiguration message may include a measurement configuration. The measurement configuration may include a frequency band on which measurement will be performed by the electronic device 101, a measurement object including information on a synchronization signal block (SSB) on which measurement will be performed, a report configuration including a condition for reporting the quality of a signal measured by the electronic device 101 based on the measurement object and/or a measurement ID including the ID of the measurement object and measurement results of the quality of the signal.

The measurement object may include information on a frequency band that is supported by nodes which may be connected to the electronic device 101 in an area where the electronic device 101 is disposed and/or a synchronization signal block (SSB) on which measurement will be performed. The measurement configuration may include at least one measurement object. According to an embodiment, the measurement object may include a first measurement object related to the measurement of the quality of a signal having a first frequency band and a second measurement object related to the measurement of the quality of a signal having a second frequency band.

According to an embodiment, the communication processor 610 may receive a measurement configuration, and may identify whether each of frequency bands included in the measurement configuration is a designated frequency band. The designated frequency band may be a frequency band in which the electronic device 101 can perform an inter-band carrier aggregation. For convenience of description, it is assumed that the electronic device 101 can perform an inter-band carrier aggregation through a combination of the first frequency band and the second frequency band.

The communication processor 610 may measure the quality of the signal based on the first measurement object and/or the second measurement object, when identifying that each of the frequency bands included in the measurement configuration is the designated frequency band. The communication processor 610 may control the first antenna module 531 to measure the quality of the signal having the first frequency band included in the first measurement object. The communication processor 610 may control the second antenna module 533 to measure the quality of the signal having the first frequency band included in the first measurement object.

When at least one quality of the quality of the signal having the first frequency band, which has been measured by the first antenna module 531, and/or the quality of the signal having the second frequency band, which has been measured by the second antenna module 533, satisfies the report condition included in the report configuration, the communication processor 610 may select any one antenna module, among the first antenna module 531 and/or the second antenna module 533, based on the results of measurement. The selected antenna module may be used in measurement of the quality of a signal that will be included in a measurement report on the quality of the signal having the first frequency band. The quality of a signal having the first frequency band, which has been measured by another antenna module (hereinafter an unselected antenna module) except a selected antenna module (e.g., the first antenna module 531), may not be included in the measurement report on the quality of the signal having the first frequency band.

The communication processor 610 may select an antenna module that has measured the higher quality, among the first antenna module 531 and/or the second antenna module 533. According to an embodiment, when the quality of the signal having the first frequency band, which has been measured by the first antenna module 531, is higher than the quality of the signal having the first frequency band, which has been measured by the second antenna module 533, the communication processor 610 may select the first antenna module 531 that has measured the higher quality, among the first antenna module 531 and/or the second antenna module 533. According to an embodiment, when the quality of the signal having the first frequency band, which has been measured by the first antenna module 531, is lower than the quality of the signal having the first frequency band, which has been measured by the second antenna module 533, the communication processor 610 may select the second antenna module 533 that has measured the higher quality, among the first antenna module 531 and/or the second antenna module 533. Hereinafter, for convenience of description, it is assumed that the quality of the signal having the first frequency band, which has been measured by the first antenna module 531, is higher than the quality of the signal having the first frequency band, which has been measured by the second antenna module 533. It is assumed that the communication processor 610 has selected the first antenna module 531.

The communication processor 610 may control a selected antenna module (e.g., the first antenna module 531) so that the selected antenna module (e.g., the first antenna module 531) measures the quality of a signal having the first frequency band for each set interval.

The communication processor 610 may transmit, to the cellular network 500, a measurement report including the quality of the signal having the first frequency band, which has been measured by a selected antenna module (e.g., the first antenna module 531), based on the quality of the signal having the first frequency band, which has been measured by the selected antenna module (e.g., the first antenna module 531), satisfying the report condition. The measurement report may include a value indicative of the quality of the signal having the first frequency band, which has been measured by a selected antenna module (e.g., the first antenna module 531), and/or the ID of an SSB corresponding to the direction of the signal measured by the selected antenna module (e.g., the first antenna module 531). The measurement report may be a measurement report except the quality of a signal having the first frequency band, which has been measured by an unselected antenna module (e.g., the second antenna module 533). For example, the measurement report may not include a value indicative of the quality of a signal having the first frequency band, which has been measured by an unselected antenna module (e.g., the second antenna module 533) and/or the ID of an SSB corresponding to the direction of a signal having the first frequency band, which has been measured by an unselected antenna module (e.g., the second antenna module 533).

The communication processor 610 may measure the quality of a signal having another frequency band (e.g., the second frequency band) included in a measurement object by using another antenna module (or an unselected antenna module) (e.g., the second antenna module 533) except a selected antenna module (e.g., the first antenna module 531). According to an embodiment, the communication processor 610 may control the second antenna module 533 so that the second antenna module 533, that is, an unselected antenna module, measures the quality of a signal having the second frequency band.

The communication processor 610 may control a selected antenna module (e.g., the second antenna module 533) so that an unselected antenna module (e.g., the second antenna module 533) measures the quality of the signal having the second frequency band for each set interval.

The communication processor 610 may transmit, to the cellular network 500, a measurement report including the quality of the signal having the second frequency band, which has been measured by an unselected antenna module (e.g., the second antenna module 533), based on the quality of the signal measured by the unselected antenna module (e.g., the second antenna module 533) satisfying the report condition. The measurement report may include a value indicative of the quality of the signal having the second frequency band, which has been measured by an unselected antenna module (e.g., the second antenna module 533), and/or the ID of an SSB corresponding to the direction of the signal measured by an unselected antenna module (e.g., the second antenna module 533). The measurement report may be a measurement report except the quality of the signal having the second frequency band, which has been measured by a selected antenna module (e.g., the first antenna module 531). For example, the measurement report may not include a value indicative of the quality of the signal having the second frequency band, which has been measured by a selected antenna module (e.g., the first antenna module 531), and/or the ID of the SSB corresponding to the direction of the signal having the second frequency band, which has been measured by the selected antenna module (e.g., the first antenna module 531).

The communication processor 610 may transmit a measurement report including the qualities of signals measured by different types of communication circuitry, in performing the measurement report on the quality of a signal having each of a plurality of frequency bands (e.g., the first frequency band and/or the second frequency band). For example, the communication processor 610 may transmit, to the cellular network 500, a measurement report including the quality of the signal having the first frequency band, which has been measured by the first antenna module 531, and may transmit a measurement report including the quality of the signal having the second frequency band, which has been measured by the second antenna module 533. Through the aforementioned method, the electronic device 101 can match communication circuitry that has performed the measurement of the quality of a signal, which is included in the measurement report that is transmitted to the cellular network 500, and communication circuitry with which communication will be performed in an inter-band carrier aggregation. Accordingly, the electronic device 101 may transmit, to the cellular network 500, the measurement report including the quality of a signal having the second frequency band only in a situation in which the electronic device 101 can perform an inter-band carrier aggregation (e.g., a situation in which the first antenna module 531 can perform the transmission and/or reception of the signal having the first frequency band and the second antenna module 533 can perform the transmission and/or reception of a signal having the second frequency band). Accordingly, the cellular network 500 may not transmit, to the electronic device 101, a signal to instruct that the electronic device 101 be connected to the second node 520 for the inter-band carrier aggregation in the situation in which the electronic device 101 cannot perform the inter-band carrier aggregation.

The communication processor 610 may not transmit, to the cellular network 500, a measurement report including the quality of the signal having the second frequency band, which has been measured by an unselected antenna module (e.g., the second antenna module 533), based on the quality of the signal measured by the unselected antenna module (e.g., the second antenna module 533) not satisfying the report condition. Accordingly, the electronic device 101 can prevent or reduce a chance of a situation in which the cellular network 500 transmits, to the electronic device 101, a signal to instruct that the electronic device 101 be connected to the second node 520 for an inter-band carrier aggregation by not transmitting, to the cellular network 500, a measurement report including the quality of the signal having the second frequency band, which has been measured by the unselected antenna module (e.g., the second antenna module 533), in a situation in which the electronic device 101 cannot perform the inter-band carrier aggregation (e.g., a situation in which the first antenna module 531 can perform the transmission and/or reception of the signal having the first frequency band, but the second antenna module 533 cannot perform the transmission and/or reception of the signal having the second frequency band).

The communication processor 610 may transmit, to the cellular network 500, a measurement report including a preset value, based on the quality of a signal that has been measured by an unselected antenna module (e.g., the second antenna module 533) not satisfying the report condition. The preset value may be different from the quality of the signal having the second frequency band, which has been measured by an unselected antenna module (e.g., the second antenna module 533). According to an embodiment, the preset value may be a value indicating that the transmission and/or reception of the signal having the second frequency band is impossible. According to an embodiment, the preset value is a value that is agreed between the electronic device 101 and the cellular network 500, and may be a value indicating that the transmission and/or reception of the signal having the second frequency band is impossible. Accordingly, the electronic device 101 can prevent or reduce a chance of a situation in which the cellular network 500 transmits, to the electronic device 101, a signal to instruct that the electronic device 101 be connected to the second node 520 for the inter-band carrier aggregation by transmitting, to the cellular network 500, a measurement report including the preset value different from the quality of the signal having the second frequency band, which has been measured by an unselected antenna module (e.g., the second antenna module 533), in the situation in which the electronic device 101 cannot perform the inter-band carrier aggregation (e.g., a situation in which the first antenna module 531 may perform the transmission and/or reception of a signal having the first frequency band, but the second antenna module 533 cannot perform the transmission and/or reception of the signal having the second frequency band).

When the state of the electronic device 101 satisfies a designated condition, the communication processor 610 may not transmit at least one measurement report, among a measurement report including the quality of the signal having the first frequency band, which has been measured by a selected antenna module (e.g., the first antenna module 531) and/or a measurement report including the quality of the signal having the second frequency band, which has been measured by an unselected antenna module (e.g., the second antenna module 533), to the cellular network 500.

The designated condition may include a condition related to a situation in which the electronic device 101 has a difficulty in performing an inter-band carrier aggregation.

According to an embodiment, the designated condition may include a condition in which the amount of remaining battery power of the electronic device 101 is equal to or smaller than (or is less than) a designated value. A situation in which the amount of remaining battery power of the electronic device 101 is equal to or smaller than (or is less than) the designated value is a situation in which additional power consumption needs to be prevented or reduced, and may be a situation in which it is difficult to perform an inter-band carrier aggregation.

According to an embodiment, the designated condition may include a condition in which the temperature of the electronic device 101 is equal to or greater than (or is greater than) a designated value. A situation in which the temperature of the electronic device 101 is equal to or greater than (or is greater than) the designated value is a situation for preventing or reducing the generation of heat, and may be a situation in which it is difficult to perform an inter-band carrier aggregation.

According to an embodiment, the designated condition may include a condition in which the electronic device 101 is in a low power mode (or a power-saving mode). A situation in which the mode of the electronic device 101 has been set as the low power mode (or the power-saving mode) is a situation in which additional power consumption needs to be prevented or reduced, and may be a situation in which it is difficult to perform an inter-band carrier aggregation.

The designated condition may include various conditions in addition to the described examples. According to an embodiment, the designated condition may include a condition in which a user input to indicate the deactivation of an inter-band carrier aggregation is received or a condition in which the deactivation of an inter-band carrier aggregation has been set.

When the state of the electronic device 101 satisfies the designated condition, the communication processor 610 can prevent or reduce a chance of a situation in which the cellular network 500 transmits, to the electronic device 101, a signal to instruct that the electronic device 101 be connected to the second node 520 for an inter-band carrier aggregation by not transmitting at least one measurement report, among a measurement report including the quality of the signal having the first frequency band, which has been measured by a selected antenna module (e.g., the first antenna module 531) and/or a measurement report including the quality of the signal having the second frequency band, which has been measured by an unselected antenna module (e.g., the second antenna module 533), to the cellular network 500.

The aforementioned embodiment may also be applied to an operation of measuring the quality of a signal for beamforming.

When the electronic device 101 operates in an independent beam management (IBM) mode, that is, a mode in which the electronic device 101 measures the quality of a reference signal that is different for each of a plurality of bands and determines the direction of a signal to be output by the electronic device 101 based on the results of the measurement of the quality, the communication processor 610, comprising processing circuitry, may transmit a measurement report including the qualities of signals measured by different types of communication circuitry, in performing the measurement report on the quality of a signal having each of a plurality of frequency bands (e.g., the first frequency band and/or the second frequency band). For example, the communication processor 610 may transmit, to the cellular network 500, a measurement report including the quality of the signal having the first frequency band, which has been measured by the first antenna module 531, and may transmit a measurement report including the quality of the signal having the second frequency band, which has been measured by the second antenna module 533.

The electronic device 101 may operate in a common beam management (CBM) mode, that is, a mode in which the electronic device 101 measures the quality of a reference signal having any one of a plurality of bands and determines the directions of the signals having the plurality of bands to be output by the electronic device 101 based on the results of the measurement of the quality.

The CBM mode may include a first mode in which the first antenna module 531 transmits and/or receives a signal having the first frequency band in a determined direction and the second antenna module 533 transmits and/or receives a signal having the second frequency band in a direction that is determined with reference to the direction of the signal output by the first antenna module 531. When the electronic device 101 operates in the first mode, the communication processor 610 may transmit a measurement report including the qualities of signals measured by different types of communication circuitry, in performing the measurement report on the quality of a signal having each of a plurality of frequency bands (e.g., the first frequency band and/or the second frequency band). For example, the communication processor 610 may transmit, to the cellular network 500, a measurement report including the quality of the signal having the first frequency band, which has been measured by the first antenna module 531, and may transmit a measurement report including the quality of the signal having the second frequency band, which has been measured by the second antenna module 533.

The CBM mode may include a second mode in which the first antenna module 531 transmits and/or receives a signal having the first frequency band and/or a signal having the second frequency band in a determined direction. When the electronic device 101 operates in the first mode, the communication processor 610 may transmit a measurement report including the quality of a signal received by the same communication circuitry in the same direction in performing the measurement report on the quality of a signal having each of a plurality of frequency bands (e.g., the first frequency band and/or the second frequency band). For example, the communication processor 610 may transmit, to the cellular network 500, a measurement report including the quality of the signal having the first frequency band, which has been measured by the first antenna module 531, and may transmit a measurement report including the quality of the signal having the second frequency band, which has been measured by the first antenna module 531. The signal having the first frequency band and the signal having the second frequency band may be signals that are transmitted in the same direction. When operating in the second mode, the electronic device 101 may perform the transmission and/or reception of a signal using only the first antenna module 531 not the second antenna module 533. Accordingly, the electronic device 101 may transmit, to the cellular network 500, a measurement report including the quality of the signal having the first frequency band, which has been measured by the first antenna module 531 and a measurement report including the quality of the signal having the second frequency band, which has been measured by the first antenna module 531.

The aforementioned embodiment may be limited if the first node 510 and the second node 520 are disposed at close locations or co-located. For example, if the first node 510 and the second node 520 are disposed at close locations or co-located, the quality of the signal having the first frequency band, which is transmitted and/or broadcasted by the first node 510 and the quality of the signal having the second frequency band, which is transmitted and/or broadcasted by the second node 520, may be the same or may have similar tendency. For example, when the quality of the signal having the first frequency band, which has been measured by the first antenna module 531, is higher than the quality of the signal having the first frequency band, which has been measured by the second antenna module 533, the quality of the signal having the second frequency band, which has been measured by the first antenna module 531 may be higher than the quality of the signal having the second frequency band, which has been measured by the second antenna module 533. If the first node 510 and the second node 520 are disposed at close locations or co-located, the quality of an inter-band carrier aggregation using different types of communication circuitry may be lower than the quality of an inter-band carrier aggregation using the same communication circuitry. Accordingly, when identifying that the quality of the signal having the first frequency band, which has been measured by the first antenna module 531, is higher than the quality of the signal having the first frequency band, which has been measured by the second antenna module 533 and the quality of the signal having the second frequency band, which has been measured by the first antenna module 531 is higher than the quality of the signal having the second frequency band, which has been measured by the second antenna module 533, the communication processor 610, comprising processing circuitry, may transmit, to the cellular network 500, a measurement report including the quality of the signal having the first frequency band, which has been measured by the first antenna module 531, and may transmit, to the cellular network 500, a measurement report including the quality of the signal having the second frequency band, which has been measured by the first antenna module 531.

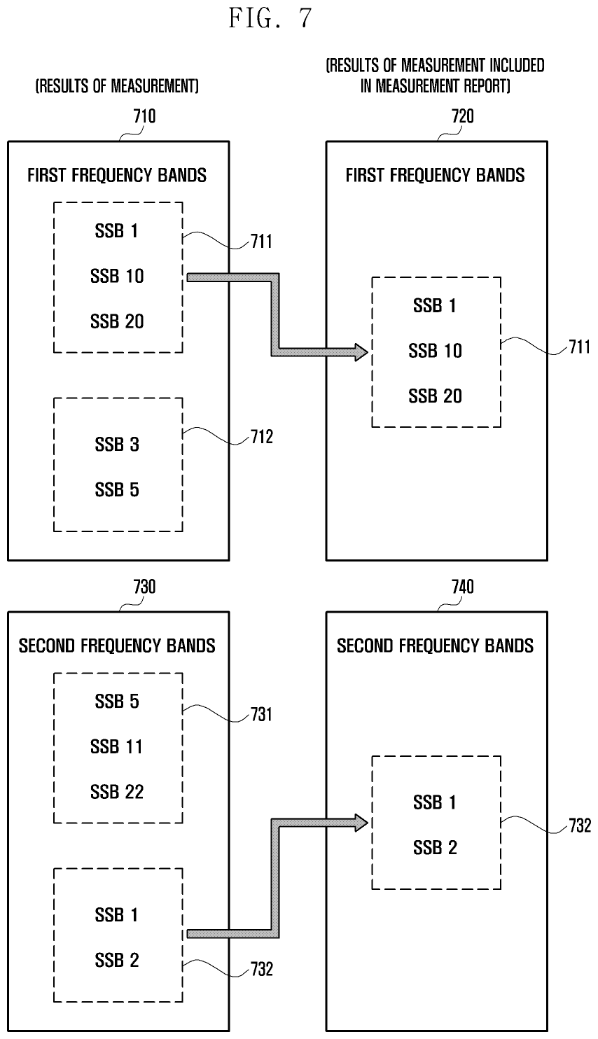

FIG. 7 is a diagram illustrating an embodiment in which an electronic device according to an embodiment transmits a measurement report to a cellular network.

An electronic device (e.g., the electronic device 101 in FIG. 6) may receive an RRC reconfiguration message from the cellular network 500, based on a cellular network (e.g., the cellular network 500 in FIG. 5A) being connected thereto. According to an embodiment, the electronic device 101 may receive the RRC reconfiguration message that is transmitted by the cellular network 500 through the third node 410 in the non-standalone mode of the first cellular communication. According to an embodiment, the electronic device 101 may receive the RRC reconfiguration message that is transmitted by the cellular network 500 through the first node 510 or the second node 520 in the standalone mode (SA) of the first cellular communication.

The RRC reconfiguration message may include a measurement configuration. The measurement configuration may include a frequency band in which the electronic device 101 will perform measurement, a measurement object including information on a synchronization signal block (SSB) on which measurement will be performed, a report configuration including a condition for reporting the quality of a signal measured by the electronic device 101 based on the measurement object and/or a measurement ID including the ID of the measurement object and measurement results of the quality of the signal.

The measurement object may include information on a frequency band that is supported by nodes which may be connected to the electronic device 101 in an area in which the electronic device 101 is disposed and/or a synchronization signal block (SSB) on which measurement will be performed. The measurement configuration may include at least one measurement object. According to an embodiment, the measurement object may include a first measurement object related to the measurement of the quality of the signal having the first frequency band and a second measurement object related to the measurement of the quality of the signal having the second frequency band.

According to an embodiment, the electronic device 101 may receive a measurement configuration, and may identify whether each of frequency bands included in the measurement configuration is a designated frequency band. The designated frequency band may be a frequency band in which the electronic device 101 can perform an inter-band carrier aggregation. For convenience of description, it is assumed that the electronic device 101 can perform an inter-band carrier aggregation through a combination of the first frequency band and the second frequency band.

The electronic device 101 may measure the quality of the signal based on the first measurement object and/or the second measurement object, when identifying that each of the frequency bands included in the measurement configuration is the designated frequency band. The electronic device 101 may control the first antenna module 531 to measure the quality of the signal having the first frequency band included in the first measurement object. The electronic device 101 may control the second antenna module 533 to measure the quality of the signal having the first frequency band included in the first measurement object.

The electronic device 101 may select any one antenna module, among the first antenna module 531 and/or the second antenna module 533 based on the results of measurement, when at least one quality, among the quality of the signal having the first frequency band, which has been measured by the first antenna module 531, and/or the quality of the signal having the second frequency band, which has been measured by the second antenna module 533, satisfies the report condition included in the report configuration.

The electronic device 101 may select an antenna module that has measured the higher quality, among the first antenna module 531 and/or the second antenna module 533. According to an embodiment, when the quality 711 of the signal having the first frequency band, which has been measured by the first antenna module 531, is higher than the quality 712 of the signal having the first frequency band, which has been measured by the second antenna module 533, the electronic device 101 may select the first antenna module 531 that has measured the higher quality, among the first antenna module 531 and/or the second antenna module 533.

The quality 711 of the signal having the first frequency band, which has been measured by a selected antenna module, among the qualities 710 of signals having the first frequency band, which have been measured by the first antenna module 531 and the second antenna module 533, may be included in a measurement report 720 of the quality of the signal having the first frequency band. The quality 712 of the signal having the first frequency band, which has been measured by an unselected antenna module, among the qualities 710 of the signals measured by the first antenna module 531 and the second antenna module 533, may not be included in a measurement report 720 of the quality of the signal having the first frequency band.

The electronic device 101 may transmit, to the cellular network 500, the measurement report 720 including the quality 711 of the signal having the first frequency band, which has been measured by a selected antenna module (e.g., the first antenna module 531), based on the quality 711 of the signal having the first frequency band, which has been measured by a selected antenna module (e.g., the first antenna module 531), satisfying the report condition. The measurement report may include a value indicative of the quality 711 of the signal having the first frequency band, which has been measured by a selected antenna module (e.g., the first antenna module 531), and/or the ID of an SSB (e.g., SSB1, SSB10, or SSB20) corresponding to the direction of the signal measured by the selected antenna module (e.g., the first antenna module 531). The measurement report 720 may be a measurement report except the quality 712 of the signal having the first frequency band, which has been measured by an unselected antenna module (e.g., the second antenna module 533). For example, the measurement report 720 may not include a value indicative of the quality 712 of the signal having the first frequency band, which has been measured by an unselected antenna module (e.g., the second antenna module 533), and/or the ID of an SSB (e.g., SSB3 or SSB5) corresponding to the direction of the signal having the first frequency band, which has been measured by an unselected antenna module (e.g., the second antenna module 533).

The electronic device 101 may measure the quality of a signal having another frequency band (e.g., the second frequency band), which is included in a measurement object, by using another antenna module (or an unselected antenna module) (e.g., the second antenna module 533) except a selected antenna module (e.g., the first antenna module 531). According to an embodiment, the electronic device 101 may control the second antenna module 533 so that the second antenna module 533, that is, an unselected antenna module, measures the quality of a signal having the second frequency band.

The electronic device 101 may control a selected antenna module (e.g., the second antenna module 533) so that an unselected antenna module (e.g., the second antenna module 533) measures the quality of a signal having the second frequency band for each set interval.

The quality 732 of a signal having the second frequency band, which has been measured by an unselected antenna module, among the qualities 730 of signals having the second frequency band, which have been measured by the first antenna module 531 and the second antenna module 533, may be included in a measurement report 740 of the quality of the signal having the second frequency band. The quality 731 of the signal having the second frequency band, which has been measured by a selected antenna module, among the qualities of the signals measured by the first antenna module 531 and the second antenna module 533, may not be included in the measurement report 740 of the quality of the signal having the second frequency band.

The electronic device 101 may transmit, to the cellular network 500, the measurement report 740 including the quality 732 of the signal having the second frequency band, which has been measured by an unselected antenna module (e.g., the second antenna module 533), based on the quality 732 of the signal measured by the unselected antenna module (e.g., the second antenna module 533) satisfying the report condition. The measurement report 740 may include a value indicative of the quality 732 of the signal having the second frequency band, which has been measured by the unselected antenna module (e.g., the second antenna module 533), and/or the ID (e.g., SSB1 or SSB2) of an SSB corresponding to the direction of the signal measured by an unselected antenna module (e.g., the second antenna module 533). The measurement report may be a measurement report except the quality 731 of the signal having the second frequency band, which has been measured by a selected antenna module (e.g., the first antenna module 531). For example, the measurement report may not include a value indicative of the quality 731 of the signal having the second frequency band, which has been measured by the selected antenna module (e.g., the first antenna module 531), and/or the ID (e.g., SSB 5, SSB 11, or SSB 22) of an SSB corresponding to the direction of the signal having the second frequency band, which has been measured by the selected antenna module (e.g., the first antenna module 531).

The electronic device 101 may transmit a measurement report including the qualities of signals measured by different types of communication circuitry, in performing the measurement report on the quality of a signal having each of a plurality of frequency bands (e.g., the first frequency band and/or the second frequency band). For example, the electronic device 101 may transmit, to the cellular network 500, the measurement report 720 including the quality 711 of the signal having the first frequency band, which has been measured by the first antenna module 531, and may transmit the measurement report 740 including the quality 732 of the signal having the second frequency band, which has been measured by the second antenna module 533. Through the aforementioned method, the electronic device 101 can match communication circuitry that has performed the measurement of the quality of a signal, which is included in the measurement report that is transmitted to the cellular network 500, and communication circuitry with which communication will be performed in an inter-band carrier aggregation. Accordingly, the electronic device 101 may transmit, to the cellular network 500, the measurement report including the quality of a signal having the second frequency band only in a situation in which the electronic device 101 can perform an inter-band carrier aggregation (e.g., a situation in which the first antenna module 531 can perform the transmission and/or reception of the signal having the first frequency band and the second antenna module 533 can perform the transmission and/or reception of a signal having the second frequency band). Accordingly, the cellular network 500 may not transmit, to the electronic device 101, a signal to instruct that the electronic device 101 be connected to the second node 520 for an inter-band carrier aggregation in a situation in which the electronic device 101 cannot perform the inter-band carrier aggregation.

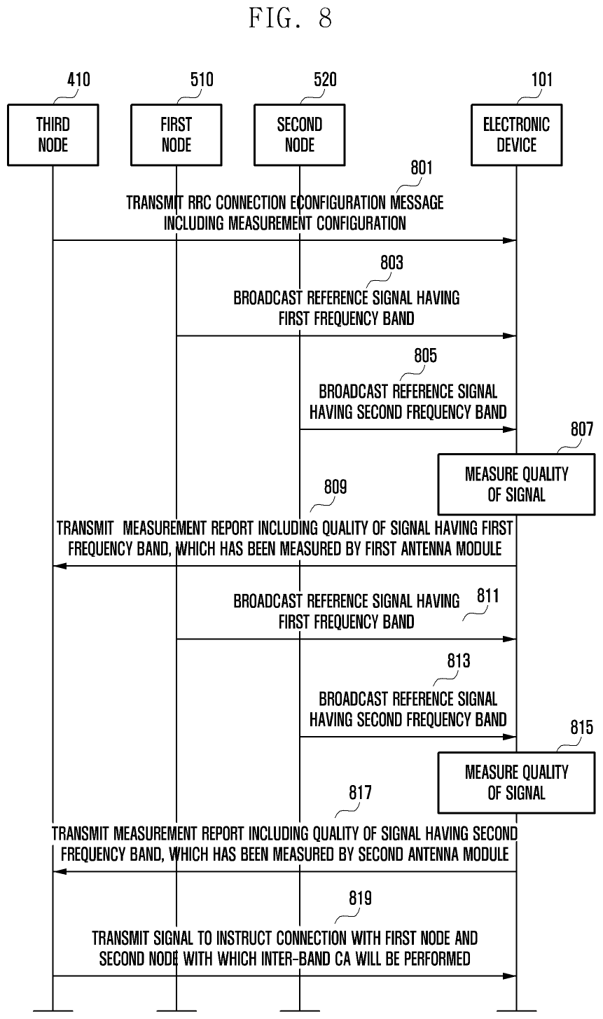

FIG. 8 is a diagram illustrating an embodiment in which an electronic device according to an embodiment transmits a measurement report for an inter-band connection.

The electronic device 101 may be connected to a third node (e.g., the master node 410 in FIG. 4A) which supports the second cellular communication in the non-standalone mode of the first cellular communication. The electronic device 101 may establish a connection with a node that supports the first cellular communication based on the results of the measurement of the quality of a signal in the state in which the electronic device 101 has been connected to the third node 410.

At operation 801, the third node 410 may transmit, to the electronic device 101, an RRC reconfiguration message including a measurement configuration.

The RRC reconfiguration message may include a measurement configuration. The measurement configuration may include a frequency band in which the electronic device 101 will perform measurement, a measurement object including information on a synchronization signal block (SSB) on which measurement will be performed, a report configuration including a condition for reporting the quality of a signal measured by the electronic device 101 based on the measurement object and/or a measurement ID including the ID of the measurement object and measurement results of the quality of the signal.

The measurement object may include information on a frequency band that is supported by nodes which may be connected, directly or indirectly, to the electronic device 101 in an area in which the electronic device 101 is disposed and/or a synchronization signal block (SSB) on which measurement will be performed. The measurement configuration may include at least one measurement object. According to an embodiment, the measurement object may include a first measurement object related to the measurement of the quality of the signal having the first frequency band and a second measurement object related to the measurement of the quality of the signal having the second frequency band.

According to an embodiment, the electronic device 101 may receive the measurement configuration, and may identify whether each of frequency bands included in the measurement configuration is a designated frequency band. The designated frequency band may be a frequency band in which the electronic device 101 can perform an inter-band carrier aggregation. For convenience of description, it is assumed that the electronic device 101 can perform an inter-band carrier aggregation through a combination of the first frequency band and the second frequency band.

At operation 803, the first node 510 may broadcast a reference signal having the first frequency band.

The reference signal may be an object the quality of which is measured by the electronic device 101.

At operation 805, the second node 520 may broadcast a reference signal having the second frequency band.

The reference signal may be an object the quality of which is measured by the electronic device 101.

At operation 807, the electronic device 101 may measure the qualities of the reference signal having the first frequency band and the reference signal having the second frequency band.

The electronic device 101 may measure the quality of the reference signal having the first frequency band, based on the first measurement object included in the measurement object, and may measure the quality of the reference signal having the second frequency band, based on the second measurement object included in the measurement object.

The electronic device 101 may measure the qualities of the signals based on the first measurement object and/or the second measurement object, when identifying that each of frequency bands included in the measurement configuration is the designated frequency band. The electronic device 101 may control the first antenna module 531 to measure the quality of the signal having the first frequency band included in the first measurement object. The electronic device 101 may control the second antenna module 533 to measure the quality of the signal having the first frequency band included in the first measurement object.

The electronic device 101 may select any one antenna module, among the first antenna module 531 and/or the second antenna module 533, based on the results of the measurement, when at least one quality, among the quality of the signal having the first frequency band, which has been measured by the first antenna module 531, and/or the quality of the signal having the second frequency band, which has been measured by the second antenna module 533, satisfies the report condition included in the report configuration.

The electronic device 101 may select an antenna module that has measured the higher quality, among the first antenna module 531 and/or the second antenna module 533. According to an embodiment, when the quality 711 of the signal having the first frequency band, which has been measured by the first antenna module 531, is higher than the quality 712 of the signal having the first frequency band, which has been measured by the second antenna module 533, the electronic device 101 may select the first antenna module 531 that has measured the higher quality, among the first antenna module 531 and/or the second antenna module 533.

The electronic device 101 may select an antenna module that has measured the higher quality, among the first antenna module 531 and/or the second antenna module 533. According to an embodiment, when the quality of the signal having the first frequency band, which has been measured by the first antenna module 531, is higher than the quality of the signal having the first frequency band, which has been measured by the second antenna module 533, the electronic device 101 may select the first antenna module 531 that has measured the higher quality, among the first antenna module 531 and/or the second antenna module 533. According to an embodiment, when the quality of the signal having the first frequency band, which has been measured by the first antenna module 531, is lower than the quality of the signal having the first frequency band, which has been measured by the second antenna module 533, the electronic device 101 may select the second antenna module 533 that has measured the higher quality, among the first antenna module 531 and/or the second antenna module 533. Hereinafter, for convenience of description, it is assumed that the quality of the signal having the first frequency band, which has been measured by the first antenna module 531, is higher than the quality of the signal having the first frequency band, which has been measured by the second antenna module 533. It is assumed that the electronic device 101 has selected the first antenna module 531.

The electronic device 101 may measure the quality of a signal having another frequency band (e.g., the second frequency band) included in the measurement object by using another antenna module (or an unselected antenna module) (e.g., the second antenna module 533) except a selected antenna module (e.g., the first antenna module 531). According to an embodiment, the electronic device 101 may control the second antenna module 533 so that the second antenna module 533, that is, an unselected antenna module, measures the quality of the signal having the second frequency band.

At operation 809, the electronic device 101 may transmit, to the third node 410, a measurement report including the quality of the signal having the first frequency band, which has been measured by the first antenna module 531.

The electronic device 101 may transmit, to the cellular network 500, the measurement report including the quality of the signal having the first frequency band, which has been measured by a selected antenna module (e.g., the first antenna module 531), based on the quality of the signal having the first frequency band, which has been measured by the selected antenna module (e.g., the first antenna module 531) satisfying the report condition. The measurement report may include a value indicative of the quality of the signal having the first frequency band, which has been measured by a selected antenna module (e.g., the first antenna module 531), and/or the ID of an SSB corresponding to the direction of the signal measured by the selected antenna module (e.g., the first antenna module 531). The measurement report may be a measurement report except the quality of a signal having the first frequency band, which has been measured by an unselected antenna module (e.g., the second antenna module 533). For example, the measurement report may not include a value indicative of the quality of a signal having the first frequency band, which has been measured by an unselected antenna module (e.g., the second antenna module 533), and/or the ID of an SSB corresponding to the direction of a signal having the first frequency band, which has been measured by the unselected antenna module (e.g., the second antenna module 533).

The electronic device 101 may not transmit, to the cellular network 500, a measurement report including the quality of the signal having the second frequency band, which has been measured by an unselected antenna module (e.g., the second antenna module 533), based on the quality of the signal measured by the unselected antenna module (e.g., the second antenna module 533) not satisfying the report condition. Accordingly, the electronic device 101 can prevent or reduce a chance of a situation in which the cellular network 500 transmits, to the electronic device 101, a signal to instruct that the electronic device 101 be connected to the second node 520 for an inter-band carrier aggregation by not transmitting, to the cellular network 500, a measurement report including the quality of the signal having the second frequency band, which has been measured by the unselected antenna module (e.g., the second antenna module 533), in a situation in which the electronic device 101 cannot perform the inter-band carrier aggregation (e.g., a situation in which the first antenna module 531 can perform the transmission and/or reception of the signal having the first frequency band, but the second antenna module 533 cannot perform the transmission and/or reception of the signal having the second frequency band).

The electronic device 101 may transmit, to the cellular network 500, the measurement report including a preset value, based on the quality of the signal measured by the unselected antenna module (e.g., the second antenna module 533) not satisfying the report condition. The preset value may be different from the quality of the signal having the second frequency band, which has been measured by the unselected antenna module (e.g., the second antenna module 533). According to an embodiment, the preset value may be a value indicating that the transmission and/or reception of the signal having the second frequency band is impossible. According to an embodiment, the preset value is a value that is agreed between the electronic device 101 and the cellular network 500, and may be a value indicating that the transmission and/or reception of the signal having the second frequency band is impossible. Accordingly, the electronic device 101 can prevent or reduce a chance of a situation in which the cellular network 500 transmits, to the electronic device 101, a signal to instruct that the electronic device 101 be connected to the second node 520 for an inter-band carrier aggregation by transmitting, to the cellular network 500, the measurement report including the preset value different from the quality of the signal having the second frequency band, which has been measured by the unselected antenna module (e.g., the second antenna module 533), in a situation in which the electronic device 101 cannot perform the inter-band carrier aggregation (e.g., a situation in which the first antenna module 531 can perform the transmission and/or reception of the signal having the first frequency band, but the second antenna module 533 cannot perform the transmission and/or reception of the signal having the second frequency band).

The electronic device 101 may perform a series of operations for a connection with the first node 510 based on the signal to instruct the connection with the first node 510, which has been transmitted by the cellular network 500, being received, and may transmit and/or receive the signal having the first frequency band to and/or from the cellular network 500 through the first node 510.

At operation 811, the first node 510 may broadcast a reference signal having the first frequency band.

The reference signal may be an object the quality of which is measured by the electronic device 101.

At operation 813, the second node 520 may broadcast a reference signal having the second frequency band.

The reference signal may be an object the quality of which is measured by the electronic device 101.

At operation 815, the electronic device 101 may measure the quality of the signal having the second frequency band based on the second measurement object.

The electronic device 101 may control the second antenna module 533 to measure the quality of the signal having the second frequency band. The electronic device 101 may identify whether the quality of the signal having the second frequency band, which has been measured by the second antenna module 533, satisfies the report condition.

At operation 817, the electronic device 101 may transmit, to the third node 410, a measurement report including the quality of the signal having the second frequency band, which has been measured by the second antenna module 533.

The electronic device 101 may transmit, to the cellular network 500, the measurement report including the quality of the signal having the second frequency band, which has been measured by an unselected antenna module (e.g., the second antenna module 533), based on the quality of the signal measured by the unselected antenna module (e.g., the second antenna module 533) satisfying the report condition. The measurement report may include a value indicative of the quality of the signal having the second frequency band, which has been measured by an unselected antenna module (e.g., the second antenna module 533), and/or the ID of an SSB corresponding to the direction of the signal measured by an unselected antenna module (e.g., the second antenna module 533). The measurement report may be a measurement report except the quality of the signal having the second frequency band, which has been measured by a selected antenna module (e.g., the first antenna module 531). For example, the measurement report may not include a value indicative of the quality of the signal having the second frequency band, which has been measured by a selected antenna module (e.g., the first antenna module 531) and/or the ID of an SSB corresponding to the direction of the signal having the second frequency band, which has been measured by a selected antenna module (e.g., the first antenna module 531).

At operation 819, the third node 410 may transmit, to the electronic device 101, a signal to instruct that the electronic device 101 be connected to the first node 510 and the second node 520 with which the inter-band carrier aggregation will be performed.

The cellular network 500 may receive the measurement report including the quality of the signal having the first frequency band, which has been measured by the first antenna module, and the measurement report including the quality of the signal having the second frequency band, which has been measured by the second antenna module, and may transmit, to the electronic device 101, a signal to instruct that the electronic device 101 be connected with the first node 510 and the second node 520 with which the inter-band carrier aggregation will be performed.

The electronic device 101 may transmit a measurement report including the qualities of signals measured by different types of communication circuitry, in performing the measurement report on the quality of a signal having each of a plurality of frequency bands (e.g., the first frequency band and/or the second frequency band). For example, the electronic device 101 may transmit, to the cellular network 500, a measurement report including the quality of a signal having the first frequency band, which has been measured by the first antenna module 531, and may transmit a measurement report including the quality of the signal having the second frequency band, which has been measured by the second antenna module 533. Through the aforementioned method, the electronic device 101 can match communication circuitry that has performed the measurement of the quality of a signal, which is included in the measurement report that is transmitted to the cellular network 500, and communication circuitry with which communication will be performed in an inter-band carrier aggregation. Accordingly, the electronic device 101 may transmit, to the cellular network 500, a measurement report including the quality of a signal having the second frequency band only in a situation in which the electronic device 101 can perform an inter-band carrier aggregation (e.g., a situation in which the first antenna module 531 can perform the transmission and/or reception of the signal having the first frequency band and the second antenna module 533 can perform the transmission and/or reception of a signal having the second frequency band). The electronic device 101 may perform a series of procedures for a connection with the second node 520, when receiving the signal to instruct that the electronic device 101 be connected to the first node 510 and the second node 520 with which the inter-band carrier aggregation will be performed.

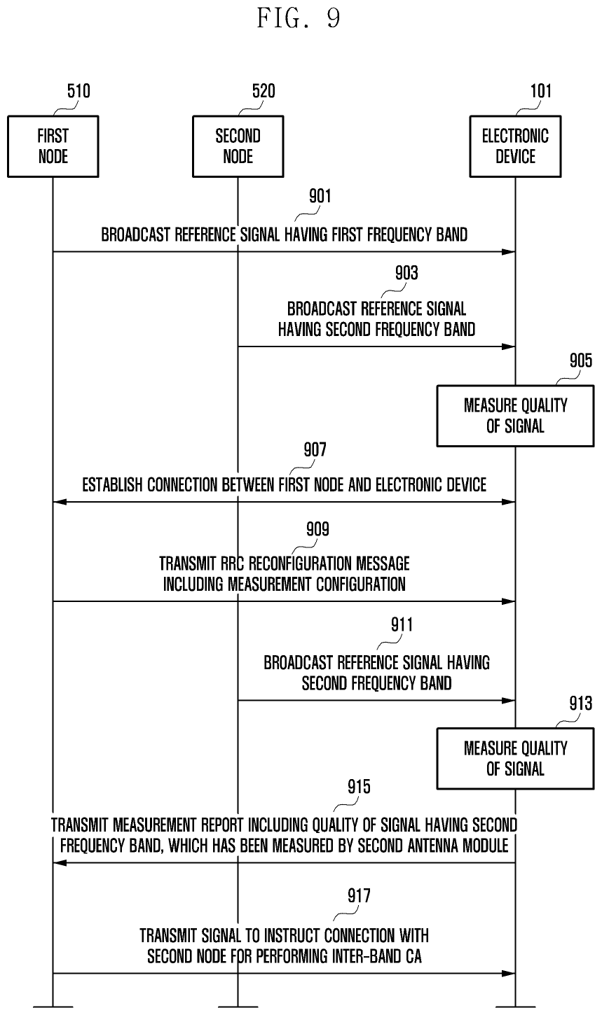

FIG. 9 is a diagram illustrating an embodiment in which an electronic device according to an embodiment transmits a measurement report for an inter-band connection.

In the standalone mode (SA) of the first cellular communication, the electronic device 101 may be first connected to one node, among the first node 510 and/or the second node 520 that support the first cellular communication. The electronic device 101 may be connected to the other node in order to perform an inter-band carrier aggregation based on the results of the measurement of the quality of a signal in the state in which the electronic device 101 has been connected to the one node.

At operation 901, the first node 510 may broadcast a reference signal having the first frequency band.

The reference signal may be an object the quality of which is measured by the electronic device 101.

At operation 903, the second node 520 may broadcast a reference signal having the second frequency band.

The reference signal may be an object the quality of which is measured by the electronic device 101.

At operation 905, the electronic device 101 may measure the qualities of the reference signal having the first frequency band and the reference signal having the second frequency band.

The electronic device 101 may compare the quality of the reference signal having the first frequency band and the quality of the reference signal having the second frequency band, and may select a node that will be connected based on the results of the comparison. According to an embodiment, when the quality of the reference signal having the first frequency band is higher than the quality of the reference signal having the second frequency band, the electronic device 101 may select the first node 510 and perform a series of procedures for a connection with the selected first node 510.

At operation 907, the electronic device 101 and the first node 510 may establish a connection between the first node 510 and the electronic device 101.

At operation 909, the first node 510 may transmit, to the electronic device 101, an RRC reconfiguration message including a measurement configuration.

The RRC reconfiguration message may include a measurement configuration. The measurement configuration may include a frequency band in which the electronic device 101 will perform measurement, a measurement object including information on a synchronization signal block (SSB) on which measurement will be performed, a report configuration including a condition for reporting the quality of a signal measured by the electronic device 101 based on the measurement object and/or a measurement ID including the ID of the measurement object and measurement results of the quality of the signal.

The measurement object may include information on a frequency band that is supported by nodes which may be connected to the electronic device 101 in an area in which the electronic device 101 is disposed and/or a synchronization signal block (SSB) on which measurement will be performed. The measurement configuration may include at least one measurement object. According to an embodiment, the measurement object may include a first measurement object related to the measurement of the quality of the signal having the first frequency band and a second measurement object related to the measurement of the quality of the signal having the second frequency band.

According to an embodiment, the electronic device 101 may receive the measurement configuration, and may identify whether each of frequency bands included in the measurement configuration is a designated frequency band. The designated frequency band may be a frequency band in which the electronic device 101 can perform an inter-band carrier aggregation. For convenience of description, it is assumed that the electronic device 101 can perform an inter-band carrier aggregation through a combination of the first frequency band and the second frequency band.

At operation 911, the second node 520 may broadcast the reference signal having the second frequency band.

The reference signal may be an object the quality of which is measured by the electronic device 101.

At operation 913, the electronic device 101 may measure the quality of the reference signal having the first frequency band and/or the quality of the reference signal having the second frequency band.

The electronic device 101 may measure the quality of the reference signal having the first frequency band based on the first measurement object included in the measurement object, and may measure the quality of the reference signal having the second frequency band based on the second measurement object included in the measurement object.

The electronic device 101 may measure the quality of the signal based on the first measurement object and/or the second measurement object, when identifying that each of the frequency bands that are included in the measurement configuration is the designated frequency band. The electronic device 101 may control the first antenna module 531 to measure the quality of the signal having the first frequency band included in the first measurement object. The electronic device 101 may control the second antenna module 533 to measure the quality of the signal having the first frequency band included in the first measurement object.

The electronic device 101 may select any one antenna module, among the first antenna module 531 and/or the second antenna module 533, based on the results of the measurement when at least one quality, among the quality of the signal having the first frequency band, which has been measured by the first antenna module 531, and/or the quality of the signal having the second frequency band, which has been measured by the second antenna module 533, satisfies the report condition included in the report configuration.

The electronic device 101 may select an antenna module that has measured the higher quality, among the first antenna module 531 and/or the second antenna module 533. According to an embodiment, when the quality 711 of the signal having the first frequency band, which has been measured by the first antenna module 531, is higher than the quality 712 of the signal having the first frequency band, which has been measured by the second antenna module 533, the electronic device 101 may select the first antenna module 531 that has measured the higher quality, among the first antenna module 531 and/or the second antenna module 533.

The electronic device 101 may select an antenna module that has measured the higher quality, among the first antenna module 531 and/or the second antenna module 533. According to an embodiment, when the quality of the signal having the first frequency band, which has been measured by the first antenna module 531, is higher than the quality of the signal having the first frequency band, which has been measured by the second antenna module 533, the electronic device 101 may select the first antenna module 531 that has measured the higher quality, among the first antenna module 531 and/or the second antenna module 533. According to an embodiment, when the quality of the signal having the first frequency band, which has been measured by the first antenna module 531, is lower than the quality of the signal having the first frequency band, which has been measured by the second antenna module 533, the electronic device 101 may select the second antenna module 533 that has measured the higher quality, among the first antenna module 531 and/or the second antenna module 533. Hereinafter, for convenience of description, it is assumed that the quality of the signal having the first frequency band, which has been measured by the first antenna module 531, is higher than the quality of the signal having the first frequency band, which has been measured by the second antenna module 533. It is assumed that the electronic device 101 has selected the first antenna module 531.

The electronic device 101 may measure the quality of a signal having another frequency band (e.g., the second frequency band) included in the measurement object by using another antenna module (or an unselected antenna module) (e.g., the second antenna module 533) except a selected antenna module (e.g., the first antenna module 531). According to an embodiment, the electronic device 101 may control the second antenna module 533 so that the second antenna module 533, that is, an unselected antenna module, measures the quality of the signal having the second frequency band.

The electronic device 101 may control the second antenna module 533 to measure the quality of the signal having the second frequency band. The electronic device 101 may identify whether the quality of the signal having the second frequency band, which has been measured by the second antenna module 533, satisfies the report condition.

At operation 915, the electronic device 101 may transmit, to the first node 510 a measurement report including the quality of the signal having the second frequency band, which has been measured by the second antenna module 533.

The electronic device 101 may transmit, to the cellular network 500, a measurement report including the quality of the signal having the second frequency band, which has been measured by an unselected antenna module (e.g., the second antenna module 533 comprising at least an antenna), based on the quality of the signal measured by the unselected antenna module (e.g., the second antenna module 533) satisfying the report condition. The measurement report may include a value indicative of the quality of the signal having the second frequency band, which has been measured by an unselected antenna module (e.g., the second antenna module 533), and/or the ID of an SSB corresponding to the direction of the signal measured by an unselected antenna module (e.g., the second antenna module 533). The measurement report may be a measurement report except the quality of the signal having the second frequency band, which has been measured by a selected antenna module (e.g., the first antenna module 531 comprising at least an antenna). For example, the measurement report may not include a value indicative of the quality of the signal having the second frequency band, which has been measured by a selected antenna module (e.g., the first antenna module 531), and/or the ID of an SSB corresponding to the direction of the signal having the second frequency band, which has been measured by a selected antenna module (e.g., the first antenna module 531).

At operation 917, the first node 510 may transmit, to the electronic device 101, a signal to instruct that the electronic device 101 be connected to the second node 520 with which an inter-band carrier aggregation will be performed.

The cellular network 500 may receive the measurement report including the quality of the signal having the first frequency band, which has been measured by the first antenna module, and the measurement report including the quality of the signal having the second frequency band, which has been measured by the second antenna module, and may transmit, to the electronic device 101, a signal to instruct that the electronic device 101 be connected to the first node 510 and the second node 520 with which the inter-band carrier aggregation will be performed.

The electronic device 101 may transmit a measurement report including the qualities of signals measured by different types of communication circuitry, in performing the measurement report on the quality of a signal having each of a plurality of frequency bands (e.g., the first frequency band and/or the second frequency band). For example, the electronic device 101 may transmit, to the cellular network 500, a measurement report including the quality of the signal having the first frequency band, which has been measured by the first antenna module 531, and may transmit a measurement report including the quality of the signal having the second frequency band, which has been measured by the second antenna module 533. Through the aforementioned method, the electronic device 101 can match communication circuitry that has performed the measurement of the quality of a signal, which is included in the measurement report that is transmitted to the cellular network 500, and communication circuitry with which communication will be performed in an inter-band carrier aggregation. Accordingly, the electronic device 101 may transmit, to the cellular network 500, the measurement report including the quality of a signal having the second frequency band only in a situation in which the electronic device 101 can perform an inter-band carrier aggregation (e.g., a situation in which the first antenna module 531 can perform the transmission and/or reception of the signal having the first frequency band and the second antenna module 533 can perform the transmission and/or reception of a signal having the second frequency band). The electronic device 101 may perform a series of procedures for a connection with the second node 520, when receiving the signal to instruct that the electronic device 101 be connected, directly or indirectly, to the first node 510 and the second node 520 with which the inter-band carrier aggregation will be performed.

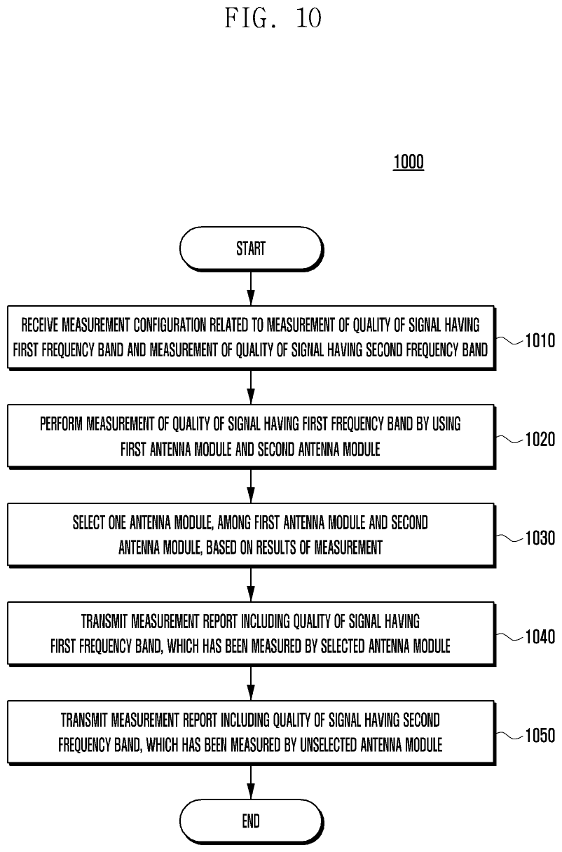

FIG. 10 is an operational flowchart 1000 illustrating an operating method of an electronic device according to an embodiment.

At operation 1010, an electronic device (e.g., the electronic device 101 in FIG. 6 or the communication processor 610 in FIG. 6) may receive, from a cellular network (e.g., the cellular network 500 in FIG. 5A), a measurement configuration related to the measurement of the quality of a signal having the first frequency band and the measurement of the quality of a signal having the second frequency band.

The electronic device 101 may receive an RRC reconfiguration message from the cellular network 500, based on a cellular network (e.g., the cellular network 500 in FIG. 5A) being connected thereto. According to an embodiment, the electronic device 101 may receive the RRC reconfiguration message that is transmitted by the cellular network 500 through the third node 410 in the non-standalone mode of the first cellular communication. According to an embodiment, the electronic device 101 may receive the RRC reconfiguration message that is transmitted by the cellular network 500 through the first node 510 or the second node 520 in the standalone mode (SA) of the first cellular communication.

The RRC reconfiguration message may include a measurement configuration. The measurement configuration may include a frequency band in which the electronic device 101 will perform measurement, a measurement object including information on a synchronization signal block (SSB) on which measurement will be performed, a report configuration including a condition for reporting the quality of a signal measured by the electronic device 101 based on the measurement object and/or a measurement ID including the ID of the measurement object and measurement results of the quality of the signal.

The measurement object may include information on a frequency band that is supported by nodes which may be connected, directly or indirectly, to the electronic device 101 in an area in which the electronic device 101 is disposed and/or a synchronization signal block (SSB) on which measurement will be performed. The measurement configuration may include at least one measurement object. According to an embodiment, the measurement object may include a first measurement object related to the measurement of the quality of the signal having the first frequency band and a second measurement object related to the measurement of the quality of the signal having the second frequency band.

According to an embodiment, the electronic device 101 may receive the measurement configuration, and may identify whether each of frequency bands included in the measurement configuration is a designated frequency band. The designated frequency band may be a frequency band in which the electronic device 101 can perform an inter-band carrier aggregation. For convenience of description, it is assumed that the electronic device 101 can perform an inter-band carrier aggregation through a combination of the first frequency band and the second frequency band.

At operation 1020, the electronic device 101 may perform the measurement of the quality of the signal having the first frequency band by using a first antenna module (e.g., the first antenna module 531 in FIG. 6) and/or a second antenna module (e.g., the second antenna module 533 in FIG. 6).

The electronic device 101 may measure the quality of the signal based on the first measurement object and/or the second measurement object, when identifying that each of the frequency bands included in the measurement configuration is the designated frequency band. The electronic device 101 may control the first antenna module 531 to measure the quality of the signal having the first frequency band included in the first measurement object. The electronic device 101 may control the second antenna module 533 to measure the quality of the signal having the first frequency band included in the first measurement object.

At operation 1030, the electronic device 101 may select one antenna module, among the first antenna module 531 and the second antenna module 533, based on the results of the measurement.

The electronic device 101 may select an antenna module that has measured the higher quality, among the first antenna module 531 and/or the second antenna module 533. According to an embodiment, when the quality of the signal having the first frequency band, which has been measured by the first antenna module 531, is higher than the quality of the signal having the first frequency band, which has been measured by the second antenna module 533, the electronic device 101 may select the first antenna module 531 that has measured the higher quality, among the first antenna module 531 and/or the second antenna module 533. According to an embodiment, when the quality of the signal having the first frequency band, which has been measured by the first antenna module 531, is lower than the quality of the signal having the first frequency band, which has been measured by the second antenna module 533, the electronic device 101 may select the second antenna module 533 that has measured the higher quality, among the first antenna module 531 and/or the second antenna module 533. Hereinafter, for convenience of description, it is assumed that the quality of the signal having the first frequency band, which has been measured by the first antenna module 531, is higher than the quality of the signal having the first frequency band, which has been measured by the second antenna module 533. It is assumed that the electronic device 101 has selected the first antenna module 531.

At operation 1040, the electronic device 101 may transmit, to the cellular network 500, a measurement report including the quality of the signal having the first frequency band, which has been measured by the selected antenna module.

The electronic device 101 may transmit, to the cellular network 500, the measurement report including the quality of the signal having the first frequency band, which has been measured by a selected antenna module (e.g., the first antenna module 531), based on the quality of the signal having the first frequency band, which has been measured by a selected antenna module (e.g., the first antenna module 531), satisfying the report condition. The measurement report may include a value indicative of the quality of the signal having the first frequency band, which has been measured by a selected antenna module (e.g., the first antenna module 531), and/or the ID of an SSB corresponding to the direction of the signal measured by the selected antenna module (e.g., the first antenna module 531). The measurement report may be a measurement report except the quality of a signal having the first frequency band, which has been measured by an unselected antenna module (e.g., the second antenna module 533). For example, the measurement report may not include a value indicative of the quality of a signal having the first frequency band, which has been measured by the unselected antenna module (e.g., the second antenna module 533), and/or the ID of an SSB corresponding to the direction of a signal having the first frequency band, which has been measured by the unselected antenna module (e.g., the second antenna module 533).

At operation 1050, the electronic device 101 may transmit, to the cellular network 500, a measurement report including the quality of the signal having the second frequency band, which has been measured by an unselected antenna module.

The electronic device 101 may transmit, to the cellular network 500, the measurement report including the quality of the signal having the second frequency band, which has been measured by the unselected antenna module (e.g., the second antenna module 533), based on the quality of the signal measured by the unselected antenna module (e.g., the second antenna module 533) satisfying the report condition. The measurement report may include a value indicative of the quality of the signal having the second frequency band, which has been measured by an unselected antenna module (e.g., the second antenna module 533), and/or the ID of an SSB corresponding to the direction of the signal measured by an unselected antenna module (e.g., the second antenna module 533). The measurement report may be a measurement report except the quality of the signal having the second frequency band, which has been measured by a selected antenna module (e.g., the first antenna module 531). For example, the measurement report may not include a value indicative of the quality of the signal having the second frequency band, which has been measured by a selected antenna module (e.g., the first antenna module 531), and/or the ID of an SSB corresponding to the direction of the signal having the second frequency band, which has been measured by a selected antenna module (e.g., the first antenna module 531).

The electronic device 101 may transmit a measurement report including the qualities of signals measured by different types of communication circuitry, in performing the measurement report on the quality of a signal having each of a plurality of frequency bands (e.g., the first frequency band and/or the second frequency band). For example, the electronic device 101 may transmit, to the cellular network 500, a measurement report including the quality of the signal having the first frequency band, which has been measured by the first antenna module 531, and may transmit a measurement report including the quality of the signal having the second frequency band, which has been measured by the second antenna module 533. Through the aforementioned method, the electronic device 101 can match communication circuitry that has performed the measurement of the quality of a signal, which is included in the measurement report that is transmitted to the cellular network 500, and communication circuitry with which communication will be performed in an inter-band carrier aggregation. Accordingly, the electronic device 101 may transmit, to the cellular network 500, the measurement report including the quality of a signal having the second frequency band only in a situation in which the electronic device 101 can perform an inter-band carrier aggregation (e.g., a situation in which the first antenna module 531 can perform the transmission and/or reception of the signal having the first frequency band and the second antenna module 533 can perform the transmission and/or reception of a signal having the second frequency band). Accordingly, the cellular network 500 may not transmit, to the electronic device 101, a signal to instruct that the electronic device 101 be connected to the second node 520 for an inter-band carrier aggregation in a situation in which the electronic device 101 cannot perform the inter-band carrier aggregation.

The electronic device 101 may not perform operation 1050 based on the quality of the signal measured by the unselected antenna module (e.g., the second antenna module 533) not satisfying the report condition. The electronic device 101 may not transmit, to the cellular network 500, a measurement report including the quality of the signal having the second frequency band, which has been measured by the unselected antenna module (e.g., the second antenna module 533), based on the quality of the signal measured by the unselected antenna module (e.g., the second antenna module 533) not satisfying the report condition.

Accordingly, the electronic device 101 can prevent or reduce a chance of a situation in which the cellular network 500 transmits, to the electronic device 101, a signal to instruct that the electronic device 101 be connected to the second node 520 for an inter-band carrier aggregation by not transmitting, to the cellular network 500, a measurement report including the quality of the signal having the second frequency band, which has been measured by the unselected antenna module (e.g., the second antenna module 533), in a situation in which the electronic device 101 cannot perform the inter-band carrier aggregation (e.g., a situation in which the first antenna module 531 can perform the transmission and/or reception of the signal having the first frequency band, but the second antenna module 533 cannot perform the transmission and/or reception of the signal having the second frequency band).

The electronic device 101 may transmit, to the cellular network 500, a measurement report including a preset value instead of operation 1050, based on the quality of the signal measured by the unselected antenna module (e.g., the second antenna module 533) not satisfying the report condition. The preset value may be different from the quality of the signal having the second frequency band, which has been measured by the unselected antenna module (e.g., the second antenna module 533). According to an embodiment, the preset value may be a value indicating that the transmission and/or reception of the signal having the second frequency band is impossible. According to an embodiment, the preset value is a value that is agreed between the electronic device 101 and the cellular network 500, and may be a value indicating that the transmission and/or reception of the signal having the second frequency band is impossible. Accordingly, the electronic device 101 can prevent or reduce a chance of a situation in which the cellular network 500 transmits, to the electronic device 101, a signal to instruct that the electronic device 101 be connected to the second node 520 for an inter-band carrier aggregation by transmitting, to the cellular network 500, a measurement report including a preset value different from the quality of the signal having the second frequency band, which has been measured by the unselected antenna module (e.g., the second antenna module 533), in a situation in which the electronic device 101 cannot perform the inter-band carrier aggregation (e.g., a situation in which the first antenna module 531 can perform the transmission and/or reception of the signal having the first frequency band, but the second antenna module 533 cannot perform the transmission and/or reception of the signal having the second frequency band).

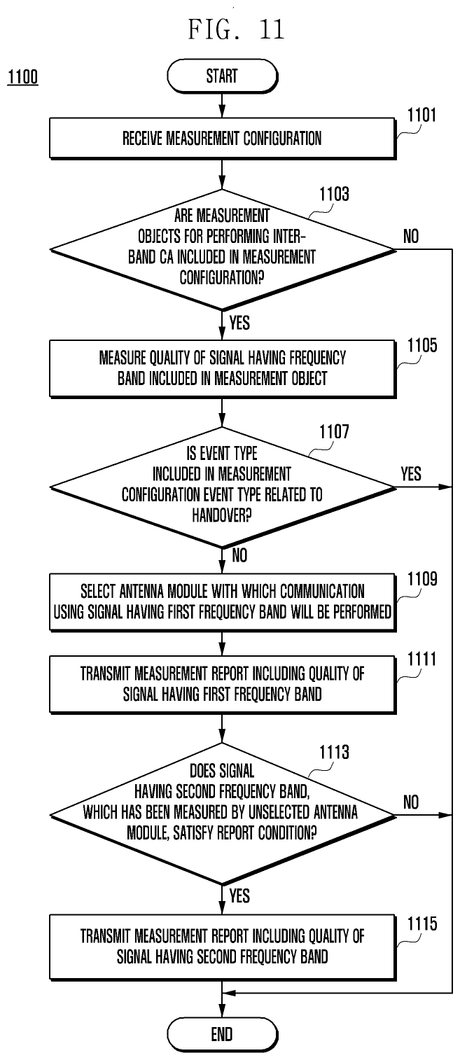

FIG. 11 is an operational flowchart 1100 illustrating an operating method of an electronic device according to an embodiment.

An electronic device (e.g., the electronic device 101 in FIG. 6 or the communication processor 610 in FIG. 6) may operate in the IBM mode, that is, a mode in which the electronic device measures the quality of a reference signal that is different for each of a plurality of bands and determines the direction of a signal to be output by the electronic device 101 based on the results of the measurement of the quality or in the CBM mode, that is, a mode in which the electronic device 101 measures the quality of a reference signal having any one of a plurality of bands and determines the directions of the signals having the plurality of bands to be output by the electronic device 101 based on the results of the measurement of the quality.

The CBM mode may include the first mode in which a first antenna module (e.g., the first antenna module 531 in FIG. 6) transmits and/or receives a signal having the first frequency band in a determined direction and a second antenna module (e.g., the second antenna module 533 in FIG. 6) transmits and/or receives a signal having the second frequency band in a direction that is determined with reference to the direction of the signal output by the first antenna module 531 or the second mode in which the first antenna module 531 transmits and/or receives a signal having the first frequency band and/or a signal having the second frequency band in a determined direction.

The following operations may be applied to a case in which the electronic device 101 operates in the IBM mode or the first mode of the CBM mode.

At operation 1101, an electronic device (e.g., the electronic device 101 in FIG. 6) may receive a measurement configuration from a cellular network (e.g., the cellular network 500 in FIG. 5A).

The electronic device 101 may receive an RRC reconfiguration message from the cellular network 500, based on a cellular network (e.g., the cellular network 500 in FIG. 5A) being connected thereto. According to an embodiment, the electronic device 101 may receive the RRC reconfiguration message that is transmitted by the cellular network 500 through the third node 410 in the non-standalone mode of the first cellular communication. According to an embodiment, the electronic device 101 may receive the RRC reconfiguration message that is transmitted by the cellular network 500 through the first node 510 or the second node 520 in the standalone mode (SA) of the first cellular communication.

The RRC reconfiguration message may include a measurement configuration. The measurement configuration may include a frequency band in which the electronic device 101 will perform measurement, a measurement object including information on a synchronization signal block (SSB) on which measurement will be performed, a report configuration including a condition for reporting the quality of a signal measured by the electronic device 101 based on the measurement object and/or a measurement ID including the ID of the measurement object and measurement results of the quality of the signal.

The measurement object may include information on a frequency band that is supported by nodes which may be connected to the electronic device 101 in an area in which the electronic device 101 is disposed and/or a synchronization signal block (SSB) on which measurement will be performed. The measurement configuration may include at least one measurement object. According to an embodiment, the measurement object may include a first measurement object related to the measurement of the quality of the signal having the first frequency band and a second measurement object related to the measurement of the quality of the signal having the second frequency band.

At operation 1103, the electronic device 101 may identify whether measurement objects for performing an inter-band carrier aggregation have been included in the measurement configuration.

The electronic device 101 may receive the measurement configuration, and may identify whether each of frequency bands included in the measurement configuration is a designated frequency band. The designated frequency band may be a frequency band in which the electronic device 101 can perform an inter-band carrier aggregation. For convenience of description, it is assumed that the electronic device 101 can perform an inter-band carrier aggregation through a combination of the first frequency band and the second frequency band.

The electronic device 101 may measure the quality of a signal having a frequency band included in the measurement configuration by using the first antenna module 531 and/or the second antenna module 533, based on the measurement objects for performing the inter-band carrier aggregation being not included in the measurement configuration (operation 1103—N), and may identify whether the quality of the signal satisfies the report condition. The electronic device 101 may transmit a measurement report including the quality of the signal, based on the quality of the signal satisfying the report condition.

At operation 1105, the electronic device 101 may measure the quality of a signal having a frequency band, which is included in the measurement object, based on the measurement objects for performing the inter-band carrier aggregation being included in the measurement configuration (operation 1103—Y).

The electronic device 101 may perform the measurement of the quality of a signal having the first frequency band by using a first antenna module (e.g., the first antenna module 531 in FIG. 6) and/or a second antenna module (e.g., the second antenna module 533 in FIG. 6).

The electronic device 101 may measure the quality of the signal based on the first measurement object and/or the second measurement object, when identifying that each of the frequency bands included in the measurement configuration is a designated frequency band. The electronic device 101 may control the first antenna module 531 to measure the quality of the signal having the first frequency band included in the first measurement object. The electronic device 101 may control the second antenna module 533 to measure the quality of the signal having the first frequency band included in the first measurement object.

At operation 1107, the electronic device 101 may identify whether an event type included in the measurement configuration is an event type related to handover.

The event type related to handover may indicate an event type in which the electronic device 101 has to perform handover from a node to which the electronic device has now been connected to another node, when a condition included in the event type is satisfied. According to an embodiment, the event type related to handover may include an event type (e.g., Event A3) in which the quality of a signal of an adjacent node is higher than the quality of a signal of a node now connected thereto by a designated size (e.g., A3 offset) or more. According to an embodiment, the event type related to handover may include an event type (e.g., event A5) in which the quality of a signal of a node now connected thereto is equal to or smaller than a specific value (e.g., threshold 1) and the quality of a signal of an adjacent node is equal to or greater than a specific value (e.g., threshold 2).

When the event type included in the measurement configuration is the event type related to handover (operation 1107—Y), the electronic device 101 may not perform a series of operations (operation 1109, operation 1111, operation 1113, and operation 1115) for transmitting a measurement report including the qualities of signals measured by different types of communication circuitry, in performing the measurement report on the quality of a signal having each of a plurality of frequency bands (e.g., the first frequency band and/or the second frequency band). According to an embodiment, based on the event type that is included in the measurement configuration being the event type related to handover (operation 1107—Y), the electronic device 101 may transmit a measurement report including a higher quality of a signal, among the quality of a signal having the first frequency band, which has been measured by the first antenna module 531, and the quality of a signal having the first frequency band, which has been measured by the second antenna module 533, to the cellular network 500, and may transmit a measurement report including a higher quality of a signal, among the quality of a signal having the second frequency band, which has been measured by the first antenna module 531 and the quality of a signal having the second frequency band, which has been measured by the second antenna module 533, to the cellular network 500. For example, pieces of communication circuitry that have measured the quality of the signal having the first frequency band and the quality of the signal having the second frequency band, which are included in the measurement report, may be the same communication circuitry.

At operation 1109, the electronic device 101 may select communication circuitry with which communication using the signal having the first frequency band will be performed, based on the event type that is included in the measurement object being not the event type related to handover (operation 1107—N).

The electronic device 101 may select an antenna module that has measured the higher quality, among the first antenna module 531 and/or the second antenna module 533. According to an embodiment, when the quality of the signal having the first frequency band, which has been measured by the first antenna module 531, is higher than the quality of the signal having the first frequency band, which has been measured by the second antenna module 533, the electronic device 101 may select the first antenna module 531 that has measured the higher quality, among the first antenna module 531 and/or the second antenna module 533. According to an embodiment, when the quality of the signal having the first frequency band, which has been measured by the first antenna module 531, is lower than the quality of the signal having the first frequency band, which has been measured by the second antenna module 533, the electronic device 101 may select the second antenna module 533 that has measured the higher quality, among the first antenna module 531 and/or the second antenna module 533. Hereinafter, for convenience of description, it is assumed that the quality of the signal having the first frequency band, which has been measured by the first antenna module 531, is higher than the quality of the signal having the first frequency band, which has been measured by the second antenna module 533. It is assumed that the electronic device 101 has selected the first antenna module 531.

At operation 1111, the electronic device 101 may transmit, to the cellular network 500, a measurement report including the quality of the signal having the first frequency band.

The electronic device 101 may transmit, to the cellular network 500, the measurement report including the quality of the signal having the first frequency band, which has been measured by a selected antenna module (e.g., the first antenna module 531), based on the quality of the signal having the first frequency band, which has been measured by a selected antenna module (e.g., the first antenna module 531), satisfying the report condition. The measurement report may include a value indicative of the quality of the signal having the first frequency band, which has been measured by a selected antenna module (e.g., the first antenna module 531), and/or the ID of an SSB corresponding to the direction of the signal measured by the selected antenna module (e.g., the first antenna module 531). The measurement report may be a measurement report except the quality of a signal having the first frequency band, which has been measured by an unselected antenna module (e.g., the second antenna module 533). For example, the measurement report may not include a value indicative of the quality of a signal having the first frequency band, which has been measured by an unselected antenna module (e.g., the second antenna module 533), and/or the ID of an SSB corresponding to the direction of a signal having the first frequency band, which has been measured by the unselected antenna module (e.g., the second antenna module 533).

At operation 1113, the electronic device 101 may identify whether the quality of the signal having the second frequency band, which has been measured by the unselected antenna module, satisfies the report condition.

The electronic device 101 may not transmit, to the cellular network 500, a measurement report including the quality of the signal having the second frequency band, which has been measured by an unselected antenna module (e.g., the second antenna module 533), based on the quality of the signal measured by the unselected antenna module (e.g., the second antenna module 533) not satisfying the report condition.

Accordingly, the electronic device 101 can prevent or reduce a chance of a situation in which the cellular network 500 transmits, to the electronic device 101, a signal to instruct that the electronic device 101 be connected to the second node 520 for an inter-band carrier aggregation by not transmitting, to the cellular network 500, a measurement report including the quality of the signal having the second frequency band, which has been measured by an unselected antenna module (e.g., the second antenna module 533), in a situation in which the electronic device 101 cannot perform the inter-band carrier aggregation (e.g., a situation in which the first antenna module 531 can perform the transmission and/or reception of the signal having the first frequency band, but the second antenna module 533 cannot perform the transmission and/or reception of the signal having the second frequency band).

The electronic device 101 may transmit, to the cellular network 500, a measurement report including a preset value, based on the quality of the signal measured by the unselected antenna module (e.g., the second antenna module 533) not satisfying the report condition (operation 1113—N). The preset value may be different from the quality of the signal having the second frequency band, which has been measured by the unselected antenna module (e.g., the second antenna module 533). According to an embodiment, the preset value may be a value indicating that the transmission and/or reception of the signal having the second frequency band is impossible. According to an embodiment, the preset value is a value that is agreed between the electronic device 101 and the cellular network 500, and may be a value indicating that the transmission and/or reception of the signal having the second frequency band is impossible. Accordingly, the electronic device 101 can prevent or reduce a chance of a situation in which the cellular network 500 transmits, to the electronic device 101, a signal to instruct that the electronic device 101 be connected to the second node 520 for an inter-band carrier aggregation by transmitting, to the cellular network 500, a measurement report including a preset value different from the quality of the signal having the second frequency band, which has been measured by an unselected antenna module (e.g., the second antenna module 533), in a situation in which the electronic device 101 cannot perform the inter-band carrier aggregation (e.g., a situation in which the first antenna module 531 can perform the transmission and/or reception of the signal having the first frequency band, but the second antenna module 533 cannot perform the transmission and/or reception of the signal having the second frequency band).

At operation 1115, the electronic device 101 may transmit, to the cellular network 500, a measurement report including the quality of the signal having the second frequency band, based on the quality of the signal having the second frequency band, which has been measured by the unselected antenna module, satisfying the report condition (operation 1113—Y).

The electronic device 101 may transmit, to the cellular network 500, a measurement report including the quality of the signal having the second frequency band, which has been measured by an unselected antenna module (e.g., the second antenna module 533), based on the quality of a signal measured by an unselected antenna module (e.g., the second antenna module 533) satisfying the report condition. The measurement report may include a value indicative of the quality of the signal having the second frequency band, which has been measured by an unselected antenna module (e.g., the second antenna module 533), and/or the ID of an SSB corresponding to the direction of the signal measured by an unselected antenna module (e.g., the second antenna module 533). The measurement report may be a measurement report except the quality of the signal having the second frequency band, which has been measured by a selected antenna module (e.g., the first antenna module 531). For example, the measurement report may not include a value indicative of the quality of the signal having the second frequency band, which has been measured by a selected antenna module (e.g., the first antenna module 531), and/or the ID of an SSB corresponding to the direction of the signal having the second frequency band, which has been measured by a selected antenna module (e.g., the first antenna module 531).

The electronic device 101 may transmit a measurement report including the qualities of signals measured by different types of communication circuitry, in performing the measurement report on the quality of a signal having each of a plurality of frequency bands (e.g., the first frequency band and/or the second frequency band). For example, the electronic device 101 may transmit, to the cellular network 500, a measurement report including the quality of the signal having the first frequency band, which has been measured by the first antenna module 531, and may transmit a measurement report including the quality of the signal having the second frequency band, which has been measured by the second antenna module 533. Through the aforementioned method, the electronic device 101 can match communication circuitry that has performed the measurement of the quality of a signal, which is included in the measurement report that is transmitted to the cellular network 500, and communication circuitry with which communication will be performed in an inter-band carrier aggregation. Accordingly, the electronic device 101 may transmit, to the cellular network 500, a measurement report including the quality of a signal having the second frequency band only in a situation in which the electronic device 101 can perform an inter-band carrier aggregation (e.g., a situation in which the first antenna module 531 can perform the transmission and/or reception of the signal having the first frequency band and the second antenna module 533 can perform the transmission and/or reception of a signal having the second frequency band). Accordingly, in the situation in which the electronic device 101 cannot perform the inter-band carrier aggregation, the cellular network 500 may not transmit, to the electronic device 101, a signal to instruct that the electronic device 101 be connected to the second node 520 for the inter-band carrier aggregation.

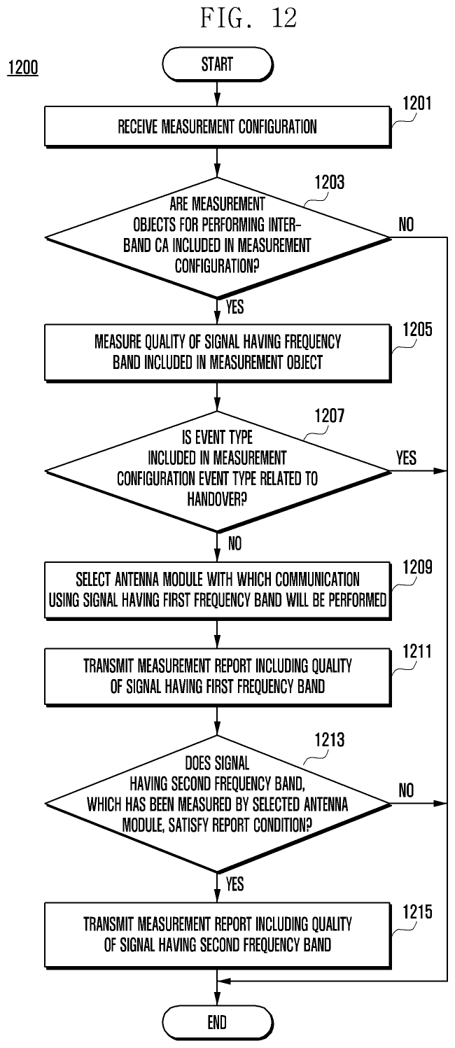

FIG. 12 is an operational flowchart illustrating an operating method of an electronic device according to an embodiment.

An electronic device (e.g., the electronic device 101 in FIG. 6 or the communication processor 610 in FIG. 6) may operate in the IBM mode, that is, a mode in which the electronic device measures the quality of a reference signal that is different for each of a plurality of bands and determines the direction of a signal to be output by the electronic device 101 based on the results of the measurement of the quality or in the CBM mode, that is, a mode in which the electronic device 101 measures the quality of a reference signal having any one of a plurality of bands and determines the directions of the signals having the plurality of bands to be output by the electronic device 101 based on the results of the measurement of the quality.

The CBM mode may include the first mode in which a first antenna module (e.g., the first antenna module 531 in FIG. 6) transmits and/or receives a signal having the first frequency band in a determined direction and a second antenna module (e.g., the second antenna module 533 in FIG. 6) transmits and/or receives a signal having the second frequency band in a direction that is determined with reference to the direction of the signal output by the first antenna module 531 or the second mode in which the first antenna module 531 transmits and/or receives a signal having the first frequency band and/or a signal having the second frequency band in a determined direction.

The following operations may be applied to a case in which the electronic device 101 operates in the second mode of the CBM mode.

At operation 1201, an electronic device (e.g., the electronic device 101 in FIG. 6) may receive a measurement configuration from a cellular network (e.g., the cellular network 500 in FIG. 5A).

The electronic device 101 may receive an RRC reconfiguration message from the cellular network 500, based on a cellular network (e.g., the cellular network 500 in FIG. 5A) being connected thereto. According to an embodiment, the electronic device 101 may receive the RRC reconfiguration message that is transmitted by the cellular network 500 through the third node 410 in the non-standalone mode of the first cellular communication. According to an embodiment, the electronic device 101 may receive the RRC reconfiguration message that is transmitted by the cellular network 500 through the first node 510 or the second node 520 in the standalone mode (SA) of the first cellular communication.

The RRC reconfiguration message may include a measurement configuration. The measurement configuration may include a frequency band in which the electronic device 101 will perform measurement, a measurement object including information on a synchronization signal block (SSB) on which measurement will be performed, a report configuration including a condition for reporting the quality of a signal measured by the electronic device 101 based on the measurement object and/or a measurement ID including the ID of the measurement object and measurement results of the quality of the signal.

The measurement object may include information on a frequency band that is supported by nodes which may be connected to the electronic device 101 in an area in which the electronic device 101 is disposed and/or a synchronization signal block (SSB) on which measurement will be performed. The measurement configuration may include at least one measurement object. According to an embodiment, the measurement object may include a first measurement object related to the measurement of the quality of the signal having the first frequency band and a second measurement object related to the measurement of the quality of the signal having the second frequency band.

At operation 1203, the electronic device 101 may identify whether measurement objects for performing an inter-band carrier aggregation have been included in the measurement configuration.

The electronic device 101 may receive the measurement configuration, and may identify whether each of frequency bands included in the measurement configuration is a designated frequency band. The designated frequency band may be a frequency band in which the electronic device 101 can perform an inter-band carrier aggregation. For convenience of description, it is assumed that the electronic device 101 can perform an inter-band carrier aggregation through a combination of the first frequency band and the second frequency band.

The electronic device 101 may measure the quality of a signal having a frequency band included in the measurement configuration by using the first antenna module 531, based on the measurement objects for performing an inter-band carrier aggregation being not included in the measurement configuration (operation 1203—N), and may identify whether the quality of the signal satisfies the report condition. The electronic device 101 may transmit a measurement report including the quality of the signal, based on the quality of the signal satisfying the report condition.

At operation 1205, the electronic device 101 may measure the quality of a signal having a frequency band, which is included in the measurement object, based on the measurement objects for performing the inter-band carrier aggregation being included in the measurement configuration (operation 1203—Y).

The electronic device 101 may perform the measurement of the quality of the signal having the first frequency band by using a first antenna module (e.g., the first antenna module 531 in FIG. 6) and/or a second antenna module (e.g., the second antenna module 533 in FIG. 6).

The electronic device 101 may measure the quality of the signal based on the first measurement object and/or the second measurement object, when identifying that each of the frequency bands that are included in the measurement configuration is the designated frequency band. The electronic device 101 may control the first antenna module 531 to measure the quality of the signal having the first frequency band included in the first measurement object. The electronic device 101 may control the second antenna module 533 to measure the quality of the signal having the first frequency band included in the first measurement object.

At operation 1207, the electronic device 101 may identify whether an event type included in the measurement configuration is an event type related to handover.

The event type related to handover may indicate an event type in which the electronic device 101 has to perform handover from a node to which the electronic device has now been connected to another node, when a condition included in the event type is satisfied. According to an embodiment, the event type related to handover may include an event type (e.g., Event A3) in which the quality of a signal of an adjacent node is higher than the quality of a signal of a node now connected thereto by a designated size (e.g., A3 offset) or more. According to an embodiment, the event type related to handover may include an event type (e.g., event A5) in which the quality of a signal of a node now connected thereto is equal to or smaller than a specific value (e.g., threshold 1) and the quality of a signal of an adjacent node is equal to or greater than a specific value (e.g., threshold 2).

When the event type included in the measurement configuration is the event type related to handover (operation 1207—Y), the electronic device 101 may not perform a series of operations (operation 1209, operation 1211, operation 1213, and operation 1215) for transmitting a measurement report including the qualities of signals measured by different types of communication circuitry in performing the measurement report on the quality of a signal having each of a plurality of frequency bands (e.g., the first frequency band and/or the second frequency band). According to an embodiment, based on the event type that is included in the measurement configuration being the event type related to handover (operation 1207—Y), the electronic device 101 may transmit, to the cellular network 500, a measurement report including a higher quality of a signal, among the quality of a signal having the first frequency band, which has been measured by the first antenna module 531, and the quality of a signal having the first frequency band, which has been measured by the second antenna module 533, and may transmit, to the cellular network 500, a measurement report including a higher quality of a signal, among the quality of a signal having the second frequency band, which has been measured by the first antenna module 531, and the quality of a signal having the second frequency band, which has been measured by the second antenna module 533. For example, the antenna modules that have measured the quality of the signal having the first frequency band and the quality of the signal having the second frequency band, which are included in the measurement report, may be the same antenna module.

At operation 1209, the electronic device 101 may select communication circuitry with which communication using a signal having the first frequency band will be performed based on the event type that is included in the measurement object being not the event type related to handover (operation 1207—N).

The electronic device 101 may select an antenna module that has measured the higher quality, among the first antenna module 531 and/or the second antenna module 533. According to an embodiment, when the quality of the signal having the first frequency band, which has been measured by the first antenna module 531, is higher than the quality of the signal having the first frequency band, which has been measured by the second antenna module 533, the electronic device 101 may select the first antenna module 531 that has measured the higher quality, among the first antenna module 531 and/or the second antenna module 533. According to an embodiment, when the quality of the signal having the first frequency band, which has been measured by the first antenna module 531, is lower than the quality of the signal having the first frequency band, which has been measured by the second antenna module 533, the electronic device 101 may select the second antenna module 533 that has measured the higher quality, among the first antenna module 531 and/or the second antenna module 533. Hereinafter, for convenience of description, it is assumed that the quality of the signal having the first frequency band, which has been measured by the first antenna module 531, is higher than the quality of the signal having the first frequency band, which has been measured by the second antenna module 533. It is assumed that the electronic device 101 has selected the first antenna module 531.

At operation 1211, the electronic device 101 may transmit, to the cellular network 500, a measurement report including the quality of the signal having the first frequency band. The electronic device 101 may transmit, to the cellular network 500, a measurement report including the quality of the signal having the first frequency band, which has been measured by a selected antenna module (e.g., the first antenna module 531), based on the quality of the signal having the first frequency band, which has been measured by the selected antenna module (e.g., the first antenna module 531), satisfying the report condition. The measurement report may include a value indicative of the quality of the signal having the first frequency band, which has been measured by a selected antenna module (e.g., the first antenna module 531), and/or the ID of an SSB corresponding to the direction of a signal, which has been measured by a selected antenna module (e.g., the first antenna module 531). The measurement report may be a measurement report except the quality of a signal having the first frequency band, which has been measured by an unselected antenna module (e.g., the second antenna module 533). For example, the measurement report may not include a value indicative of the quality of a signal having the first frequency band, which has been measured by an unselected antenna module (e.g., the second antenna module 533), and/or the ID of an SSB corresponding to the direction of a signal having the first frequency band, which has been measured by an unselected antenna module (e.g., the second antenna module 533 comprising at least an antenna).

At operation 1213, the electronic device 101 may identify whether the quality of the signal having the second frequency band, which has been measured by the selected antenna module, satisfies the report condition.

The electronic device 101 may operate in the second mode of the CBM mode in which the first antenna module 531 transmits and/or receives a signal having the first frequency band and/or a signal having the second frequency band in a determined direction. Accordingly, the electronic device 101 may measure the quality of a signal having the second frequency band by using a selected antenna module, and may identify whether the measured quality satisfies the report condition.

The electronic device 101 may not transmit, to the cellular network 500, a measurement report including the quality of the signal having the second frequency band, which has been measured by a selected antenna module (e.g., the first antenna module 531), based on the quality of the signal measured by the selected antenna module (e.g., the first antenna module 531) not satisfying the report condition.

Accordingly, the electronic device 101 can prevent or reduce a chance of a situation in which the cellular network 500 transmits, to the electronic device 101, a signal to instruct that the electronic device 101 be connected to the second node 520 for an inter-band carrier aggregation by not transmitting, to the cellular network 500, a measurement report including the quality of the signal having the second frequency band, which has been measured by a selected antenna module (e.g., the first antenna module 531), in a situation in which the electronic device 101 cannot perform the inter-band carrier aggregation (e.g., a situation in which the first antenna module 531 can perform the transmission and/or reception of the signal having the first frequency band, but the first antenna module 531 cannot perform the transmission and/or reception of the signal having the second frequency band).

The electronic device 101 may transmit, to the cellular network 500, a measurement report including a preset value, based on the quality of the signal measured by a selected antenna module (e.g., the first antenna module 531) not satisfying the report condition (operation 1213—N). The preset value may be different from the quality of the signal having the second frequency band, which has been measured by the selected antenna module (e.g., the first antenna module 531). According to an embodiment, the preset value may be a value indicating that the transmission and/or reception of the signal having the second frequency band is impossible. According to an embodiment, the preset value is a value that is agreed between the electronic device 101 and the cellular network 500, and may be a value indicating that the transmission and/or reception of the signal having the second frequency band is impossible. Accordingly, the electronic device 101 can prevent or reduce a chance of a situation in which the cellular network 500 transmits, to the electronic device 101, a signal to instruct that the electronic device 101 be connected to the second node 520 for an inter-band carrier aggregation by transmitting, to the cellular network 500, a measurement report including a preset value different from the quality of the signal having the second frequency band, which has been measured by a selected antenna module (e.g., the first antenna module 531), in a situation in which the electronic device 101 cannot perform the inter-band carrier aggregation (e.g., a situation in which the first antenna module 531 can perform the transmission and/or reception of the signal having the first frequency band, but the first antenna module 531 cannot perform the transmission and/or reception of the signal having the second frequency band).

At operation 1215, the electronic device 101 may transmit, to the cellular network 500, a measurement report including the quality of the signal having the second frequency band, based on the quality of the signal having the second frequency band, which has been measured by the selected antenna module, satisfying the report condition (operation 1213—Y).

The electronic device 101 may transmit, to the cellular network 500, a measurement report including the quality of the signal having the second frequency band, which has been measured by a selected antenna module (e.g., the first antenna module 531), based on the quality of the signal, which has been measured by the selected antenna module (e.g., the first antenna module 531), satisfying the report condition. The measurement report may include a value indicative of the quality of a signal having the second frequency band, which has been measured by a selected antenna module (e.g., the first antenna module 531 comprising at least an antenna), and/or the ID of an SSB corresponding to the direction of a signal, which has been measured by a selected antenna module (e.g., the first antenna module 531).

The electronic device 101 may transmit a measurement report including the qualities of signals measured by different types of communication circuitry in performing the measurement report on the quality of a signal having each of a plurality of frequency bands (e.g., the first frequency band and/or the second frequency band). For example, the electronic device 101 may transmit, to the cellular network 500, a measurement report including the quality of the signal having the first frequency band, which has been measured by the first antenna module 531, and may transmit a measurement report including the quality of the signal having the second frequency band, which has been measured by the first antenna module 531. Through the aforementioned method, the electronic device 101 can match communication circuitry that has performed the measurement of the quality of a signal, which is included in the measurement report that is transmitted to the cellular network 500, and communication circuitry with which communication will be performed in an inter-band carrier aggregation. Accordingly, the electronic device 101 may transmit, to the cellular network 500, a measurement report including the quality of a signal having the second frequency band only in a situation in which the electronic device 101 can perform an inter-band carrier aggregation (e.g., a situation in which the first antenna module 531 can perform the transmission and/or reception of a signal having the first frequency band, and the first antenna module 531 can perform the transmission and/or reception of a signal having the second frequency band). Accordingly, the cellular network 500 may not transmit, to the electronic device 101, a signal to instruct that the electronic device 101 be connected to the second node 520 for an inter-band carrier aggregation in a situation in which the electronic device 101 cannot perform the inter-band carrier aggregation.

An electronic device according to an embodiment may include a first antenna module comprising an antenna. The electronic device may include a second antenna module comprising an antenna. The electronic device may include a communication processor. The communication processor may receive, from a cellular network, a measurement configuration (measConfig) related to the measurement of the quality of a signal having a first frequency band and the measurement of the quality of a signal having a second frequency band. The communication processor may measure the quality of the signal having the first frequency band by using the first antenna module and the second antenna module. The communication processor may select one antenna module among the first antenna module and the second antenna module, based on measurement results. The communication processor may transmit, to the cellular network, a measurement report including the quality of the signal having the first frequency band, which has been measured by a selected antenna module, when the quality of the signal having the first frequency band, which has been measured by the selected antenna module, satisfies a condition included in the measurement configuration. The communication processor may be configured to transmit, to the cellular network, a measurement report including the quality of a signal having the second frequency band, which has been measured by an unselected antenna module, when the quality of the signal having the second frequency band, which has been measured by the unselected antenna module, satisfies the condition included in the measurement configuration.

In the electronic device according to an embodiment, the communication processor may be configured to not transmit, to the cellular network, the measurement report including the quality of the signal having the second frequency band, which has been measured by the unselected antenna module, when the quality of the signal having the second frequency band, which has been measured by the unselected antenna module, does not satisfy the condition included in the measurement configuration.

In the electronic device according to an embodiment, the communication processor may be configured to transmit, to the cellular network, a measurement report including a preset value, when the quality of the signal having the second frequency band, which has been measured by the unselected antenna module, does not satisfy the condition included in the measurement configuration.

In the electronic device according to an embodiment, the preset value is a value different from a value indicative of the quality of the signal having the second frequency band.

In the electronic device according to an embodiment, the communication processor may be configured to transmit, to the cellular network, a measurement report except the quality of the signal having the second frequency band, which has been measured by the selected antenna module.

In the electronic device according to an embodiment, the communication processor may be configured to transmit, to the cellular network, a measurement report except the quality of the signal having the first frequency band, which has been measured by the unselected antenna module.

In the electronic device according to an embodiment, the communication processor may be configured to not transmit at least one measurement report, among the measurement report including the quality of the signal having the first frequency band, which has been measured by the selected antenna module, and/or the measurement report including the quality of the signal having the second frequency band, which has been measured by the unselected antenna module, to the cellular network, when a state of the electronic device satisfies a designated condition.

In the electronic device according to an embodiment, the communication processor may be configured to transmit, to the cellular network, a measurement report including the quality of the signal having the first frequency band, which has been measured by the selected antenna module, and the quality of the signal having the second frequency band, which has been measured by the selected antenna module, if the electronic device supports a common beam management (CBM) mode in which a beam is controlled by one type of communication circuitry of the first antenna module and the second antenna module.

In the electronic device according to an embodiment, the communication processor may be configured to transmit, to the cellular network, a measurement report including the quality of the signal having the first frequency band, which has been measured by the selected antenna module, and the quality of the signal having the second frequency band, which has been measured by the unselected antenna module, when the electronic device supports a common beam management (CBM) mode in which a beam is controlled by using both the first antenna module and the second antenna module or an independent beam management (IBM) mode in which the first antenna module and the second antenna module control beams independently.

In the electronic device according to an embodiment, the communication processor may be configured to transmit, to the cellular network, the measurement report including the quality of the signal having the second frequency band, which has been measured by the selected antenna module, when the quality of the signal having the second frequency band, which has been measured by the selected antenna module, is higher than the quality of the signal having the second frequency band, which has been measured by the unselected antenna module.

An operating method of an electronic device according to an embodiment may include an operating of receiving, from a cellular network, a measurement configuration (measConfig) related to the measurement of a quality of a signal having a first frequency band and measurement of a quality of a signal having a second frequency band. The operating method of the electronic device may include an operation of measuring the quality of the signal having the first frequency band by using the first antenna module and the second antenna module. The operating method of the electronic device may include an operating of selecting one antenna module among the first antenna module and the second antenna module, based on the results of the measurement. The operating method of the electronic device may include an operating of transmitting, to the cellular network, a measurement report including the quality of the signal having the first frequency band, which has been measured by a selected antenna module, when the quality of the signal having the first frequency band, which has been measured by the selected antenna module, satisfies a condition included in the measurement configuration. The operating method of the electronic device may include an operating of transmitting, to the cellular network, a measurement report including the quality of the signal having the second frequency band, which has been measured by an unselected antenna module, when the quality of the signal having the second frequency band, which has been measured by the unselected antenna module, satisfies the condition included in the measurement configuration.

Each embodiment herein may be used in combination with any other embodiment(s) described herein.

The operating method of the electronic device according to an embodiment may further include an operation of performing a configuration so that the measurement report including the quality of the signal having the second frequency band, which has been measured by the unselected antenna module, is not transmitted to the cellular network when the quality of the signal having the second frequency band, which has been measured by the unselected antenna module, does not satisfy the condition included in the measurement configuration.

The operating method of the electronic device according to an embodiment may further include an operation of transmitting, to the cellular network, a measurement report including a preset value, when the quality of the signal having the second frequency band, which has been measured by the unselected antenna module, does not satisfy the condition included in the measurement configuration.

In the operating method of the electronic device according to an embodiment, the preset value may be a value different from a value indicative of the quality of the signal having the second frequency band.

In the operating method of the electronic device according to an embodiment, the operating of transmitting, to the cellular network, a measurement report including the quality of the signal having the second frequency band, which has been measured by an unselected antenna module may include an operation of transmitting, to the cellular network, a measurement report except the quality of the signal having the second frequency band, which has been measured by the selected antenna module.

In the operating method of the electronic device according to an embodiment, the operating of transmitting, to the cellular network, a measurement report including the quality of the signal having the first frequency band, which has been measured by a selected antenna module may include an operation of transmitting, to the cellular network, a measurement report except the quality of the signal having the first frequency band, which has been measured by the unselected antenna module.

The operating method of the electronic device according to an embodiment may further include an operation of performing a configuration so that at least one measurement report, among the measurement report including the quality of the signal having the first frequency band, which has been measured by the selected antenna module, and/or the measurement report including the quality of the signal having the second frequency band, which has been measured by the unselected antenna module, is not transmitted to the cellular network, when a state of the electronic device satisfies a designated condition.

The operating method of the electronic device according to an embodiment may further include an operation of transmitting, to the cellular network, a measurement report including the quality of the signal having the first frequency band, which has been measured by the selected antenna module, and the quality of the signal having the second frequency band, which has been measured by the selected antenna module, if the electronic device supports a common beam management (CBM) mode in which a beam is controlled by one type of communication circuitry of the first antenna module and the second antenna module.

The operating method of the electronic device according to an embodiment may further include an operation of transmitting, to the cellular network, a measurement report including the quality of the signal having the first frequency band, which has been measured by the selected antenna module, and the quality of the signal having the second frequency band, which has been measured by the unselected antenna module, when the electronic device supports a common beam management (CBM) mode in which a beam is controlled by using both the first antenna module and the second antenna module or an independent beam management (IBM) mode in which the first antenna module and the second antenna module control beams independently.

The operating method of the electronic device according to an embodiment may further include an operation of transmitting, to the cellular network, the measurement report including the quality of the signal having the second frequency band, which has been measured by the selected antenna module, when the quality of the signal having the second frequency band, which has been measured by the selected antenna module, is higher than the quality of the signal having the second frequency band, which has been measured by the unselected antenna module.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s).

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various example embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
a first antenna module comprising an antenna;
a second antenna module comprising an antenna; and
a communication processor,
wherein the communication processor is configured to:
receive, from a cellular network, a measurement configuration related to measurement of a quality of a signal of a first frequency band and measurement of a quality of a signal of a second frequency band,
measure the quality of the signal of the first frequency band using at least the first antenna module and the second antenna module,
select an antenna module among the first antenna module and the second antenna module, based on results of the measurement,
transmit, to the cellular network, a measurement report comprising the quality of the signal of the first frequency band, which has been measured via at least a selected antenna module, when the quality of the signal of the first frequency band, which has been measured via at least the selected antenna module, satisfies a condition included in the measurement configuration, and
transmit, to the cellular network, a measurement report comprising the quality of the signal of the second frequency band, which has been measured via at least an unselected antenna module, when the quality of the signal of the second frequency band, which has been measured via at least the unselected antenna module, satisfies the condition included in the measurement configuration.

2. The electronic device of claim 1, wherein the communication processor is configured to not transmit, to the cellular network, the measurement report comprising the quality of the signal of the second frequency band, which has been measured via at least the unselected antenna module, when the quality of the signal of the second frequency band, which has been measured via at least the unselected antenna module, does not satisfy the condition included in the measurement configuration.

3. The electronic device of claim 1, wherein the communication processor is configured to transmit, to the cellular network, a measurement report comprising a preset value, when the quality of the signal of the second frequency band, which has been measured via at least the unselected antenna module, does not satisfy the condition included in the measurement configuration.

4. The electronic device of claim 3, wherein the preset value is a value different from a value indicative of the quality of the signal of the second frequency band.

5. The electronic device of claim 1, wherein the communication processor is configured to transmit, to the cellular network, a measurement report except the quality of the signal of the second frequency band, which has been measured via at least the selected antenna module.

6. The electronic device of claim 1, wherein the communication processor is configured to transmit, to the cellular network, a measurement report except the quality of the signal of the first frequency band, which has been measured via at least the unselected antenna module.

7. The electronic device of claim 1, wherein the communication processor is configured to not transmit at least one measurement report, among the measurement report comprising the quality of the signal of the first frequency band, which has been measured via at least the selected antenna module, and/or the measurement report comprising the quality of the signal of the second frequency band, which has been measured via at least the unselected antenna module, to the cellular network, when a state of the electronic device satisfies a designated condition.

8. The electronic device of claim 1, wherein the communication processor is configured to control to transmit, to the cellular network, a measurement report comprising the quality of the signal of the first frequency band, which has been measured via at least the selected antenna module, and the quality of the signal of the second frequency band, which has been measured via at least the selected antenna module, if the electronic device supports a common beam management (CBM) mode in which a beam is controlled by one type of communication circuitry of the first antenna module and the second antenna module.

9. The electronic device of claim 1, wherein the communication processor is configured to transmit, to the cellular network, a measurement report comprising the quality of the signal of the first frequency band, which has been measured via at least the selected antenna module, and the quality of the signal of the second frequency band, which has been measured via at least the unselected antenna module, when the electronic device supports a common beam management (CBM) mode in which a beam is controlled by using both the first antenna module and the second antenna module, and/or an independent beam management (IBM) mode in which the first antenna module and the second antenna module control beams independently.

10. The electronic device of claim 8, wherein the communication processor is configured to transmit, to the cellular network, the measurement report comprising the quality of the signal of the second frequency band, which has been measured via at least the selected antenna module, when the quality of the signal comprising the second frequency band, which has been measured via at least the selected antenna module, is higher than the quality of the signal of the second frequency band, which has been measured via at least the unselected antenna module.

11. An operating method of an electronic device, comprising:
receiving, from a cellular network, a measurement configuration related to measurement of a quality of a signal having a first frequency band and measurement of a quality of a signal having a second frequency band,
measuring the quality of the signal having the first frequency band using at least a first antenna module comprising an antenna and a second antenna module comprising an antenna,
selecting one antenna module among a first antenna module and a second antenna module, based on results of the measurement,
transmitting, to the cellular network, a measurement report comprising the quality of the signal of the first frequency band, which has been measured by a selected antenna module, when the quality of the signal having the first frequency band, which has been measured via the selected antenna module, satisfies a condition included in the measurement configuration, and
transmitting, to the cellular network, a measurement report comprising the quality of the signal of the second frequency band, which has been measured via an unselected antenna module, when the quality of the signal having the second frequency band, which has been measured by the unselected antenna module, satisfies the condition included in the measurement configuration.

12. The operating method of claim 11, further comprising:
configuring not to transmit the measurement report comprising the quality of the signal of the second frequency band, which has been measured via the unselected antenna module, to the cellular network when the quality of the signal of the second frequency band, which has been measured via the unselected antenna module, does not satisfy the condition included in the measurement configuration.

13. The operating method of claim 11, further comprising transmitting, to the cellular network, a measurement report comprising a preset value, when the quality of the signal of the second frequency band, which has been measured via the unselected antenna module, does not satisfy the condition included in the measurement configuration.

14. The operating method of claim 13, wherein the preset value is a value different from a value indicative of the quality of the signal having the second frequency band.

15. The operating method of claim 11, wherein transmitting, to the cellular network, a measurement report comprising the quality of the signal of the second frequency band, which has been measured via an unselected antenna module comprises transmitting, to the cellular network, a measurement report except the quality of the signal having the second frequency band, which has been measured via the selected antenna module.

16. The operating method of claim 11, wherein transmitting, to the cellular network, a measurement report comprising the quality of the signal having the first frequency band, which has been measured via a selected antenna module, comprises transmitting, to the cellular network, a measurement report except the quality of the signal having the first frequency band, which has been measured via the unselected antenna module.

17. The operating method of claim 11, further comprising:
configuring not to transmit at least one measurement report, among the measurement report comprising the quality of the signal of the first frequency band, which has been measured via the selected antenna module, and/or the measurement report comprising the quality of the signal of the second frequency band, which has been measured by the unselected antenna module, to the cellular network, when a state of the electronic device satisfies a designated condition.

18. The operating method of claim 11, further comprising transmitting, to the cellular network, a measurement report comprising the quality of the signal of the first frequency band, which has been measured via the selected antenna module, and the quality of the signal having the second frequency band, which has been measured by the selected antenna module, when the electronic device supports a common beam management (CBM) mode in which a beam is controlled by a type of communication circuitry of the first antenna module and the second antenna module.

19. The operating method of claim 11, further comprising transmitting, to the cellular network, a measurement report comprising the quality of the signal of the first frequency band, which has been measured via the selected antenna module, and the quality of the signal of the second frequency band, which has been measured via the unselected antenna module, when the electronic device supports a common beam management (CBM) mode in which a beam is controlled by using both the first antenna module and the second antenna module and/or an independent beam management (IBM) mode in which the first antenna module and the second antenna module control beams independently.

20. The operating method of claim 18, further comprising transmitting, to the cellular network, the measurement report comprising the quality of the signal of the second frequency band, which has been measured via the selected antenna module, when the quality of the signal of the second frequency band, which has been measured by the selected antenna module, is higher than the quality of the signal of the second frequency band, which has been measured via the unselected antenna module.
